(19) United States
(12) Patent Application Publication
(10) Pub. No.: US 2015/0082993 A1
(43) Pub. Date: Mar. 26, 2015

(54) POPCORN MACHINES AND METHODS OF MAKING AND USING THE SAME

(71) Applicant: Paramount Inc., Wilmington, DE (US)

(72) Inventors: Robert A. Johnson, Western Springs, IL (US); Nathan Johnson, Western Springs, IL (US); Harold Raymond Pieroway, Ottawa (CA); Nicholas J. Lenzen, Wood Dale, IL (US)

(73) Assignee: Paramount Inc., Wilmington, DE (US)

(21) Appl. No.: 14/034,163

(22) Filed: Sep. 23, 2013

(51) Int. Cl. A23L 1/18

(52) U.S. Cl. CPC A23L 1/1812
USPC 99/323.5

(57) ABSTRACT

Popcorn machines are disclosed having a construction that includes an upper unit spaced from and above a base unit and a plurality of columns that are spaced apart and slidably connected to the upper and base units thereby defining a cavity, wherein such popcorn machines include a first side having an opening through which the cavity is accessible and at least a second side having an opening through which the cavity is accessible. Side panels having vertical rails and a portion of a hinge along one side and a latch along another side, and a configuration of a popcorn machine having edge lighting, are disclosed.

### BACKGROUND OF THE INVENTION

1. Field of the Invention

The present invention generally relates to corn popping apparatus, such as popcorn machines, and more particularly to structural improvements relating to the assembly, use and maintenance of popcorn machines and components thereof.

2. Discussion of the Prior Art

Corn popping apparatus may take various forms, but when intending to make repeated batches of popped corn, it is common to utilize what generally is known as a popcorn machine, with such a machine having a housing or cabinet, which includes a cavity in which a heated kettle assembly is located to pop the corn and in which the popped corn is at least collected and temporarily stored. The housing may include glass or transparent side panels through which the kettle assembly and popped corn within the cavity may be viewed. This may serve to drive desirability for the popped corn, while also displaying the quantity of popped corn available. Indeed, the desirability may periodically be enhanced while corn is being popped, due to the vapors that escape the kettle assembly during the cooking process, as well as the steam that may rise from the cooked popped corn.

Such popcorn machines may be configured to stand alone, such as when placed on a counter or table top. The machines also may be configured to be placed on top of a cart, which may for decoration have a nostalgic appearance, or a cart may be incorporated into a base unit of a machine. A cart may be used for portability of the machine and/or to provide a more fanciful display. These types of machines may be in configurations and of sizes that would be suitable for personal or home use. They also may be somewhat larger, such as for use in a business in any of a number of settings, for example, in waiting areas of businesses that do not otherwise serve food, such as automobile dealerships or banks, or in restaurants, or establishments that might be called a bar or tavern. Frankly, they may be used in any suitable environment having a power outlet or socket and where it might be desirable to be able to enjoy freshly popped corn. The inventive aspects disclosed herein can be applied to machines of these various sizes, and some may be useful even with larger machines that are intended for extensive production, such as in movie theaters or other vending environments.

The common structure for the housing of many popcorn machines generally includes a base unit, four corner columns, glass or other transparent side panels, and an upper unit. The side panels typically are fixed between the columns on three sides of the housing, while on a fourth side there may be hinge assemblies for pivotal connection of one or more side panels that serve as operator access doors. It is common for the base unit to be hard wired to a power supply cord that may be plugged into a power source, such as a wall socket. The hard wiring of the machine generally continues throughout the housing of prior art popcorn machines by routing wires through one of the columns and upward to the upper unit.

The base unit or upper unit may include a controller and/or switches to enable an operator to manage the supply of power to the machine's electrical components. For instance, the base unit also may include a warming element below a floor of the cavity, to keep the popped corn warm. Power may be supplied to the upper unit for connection to one or more additional electrical components, such as to a kettle assembly and its electric heating element, to one or more lights, whether mounted within the upper unit in a manner to illuminate within the cavity or to illuminate signage on one or more faces of the upper unit, and/or to a fan or blower that may be used to vent or exhaust from the cavity steam or vapors that may be generated during or after the corn cooking process.

The construction of a popcorn machine, including the housing, with its hardwiring from a power supply cord and throughout the machine to all of its electrical components, generally includes full assembly within a manufacturer's facility, including fixedly connecting together the base unit, columns, side panels and upper unit, to form a completed machine, including being fitted with a removable kettle assembly. Such complete assembly of a popcorn machine by the manufacturer, however, generally presents an apparatus to be shipped to a customer that essentially represents a fairly heavy, large and awkward, glass-sided box that can create at least three issues relating to shipping. First, this tends to result in high shipping costs because some freight is priced based on the cubic dimensions of the container, and a fair amount of the machine represents a large, somewhat empty enclosure. Second, this tends to result in high shipping costs because the resulting large, heavy, awkward container used to ship a completely assembled machine requires shipment by a truck that has a rear lift. Third, shipping a completely assembled machine tends to result in higher overall costs due to warranty claims because the vertical glass side panels of the machine are difficult to protect and are subjected to increased likelihood of breakage during shipment. Given the common use of cardboard and other non-rigid materials for the outer walls of shipping containers for popcorn machines, the risk of glass breakage or other damage to the upper or base units can be significant. Thus, from a shipping standpoint, a completely assembled machine is problematic, yet it is believed that this indeed is the way in which all such popcorn machines presently are being shipped.

Current assembled popcorn machines also typically present several difficulties to an operator. For instance, with three of the transparent side panels being fixed in place, patrons who may purchase popped corn from the operator, or guests that may receive popcorn from a personal operator, are permitted to see the accumulation of debris associated with popped corn, whether bits of popped corn, unpopped kernels, oil residue, salt, or the like. To clean within the cavity of the housing, an operator has only one access to the inside of the cavity, through the operator access door(s) on one side of the machine. This can be difficult, as the operator must reach through the machine to reach the opposed side walls, the ceiling (or bottom surface of the upper unit) and the floor of the cavity (or top surface of the base unit).

This is still more problematic because popcorn machines commonly have kettle assembly supports that are fixedly mounted to the ceiling of the cavity (or bottom surface of the upper unit) and which extend downward to suspend the kettle assembly within the cavity. The kettle assembly supports typically are in the form of two brackets that are made of stamped metal. Therefore, they present awkward obstacles to cleaning the surfaces within the cavity and may have fairly sharp edges that can present a hazard or risk of injury when inadvertently contacted by a user.

The fixed location of the kettle assembly supports, suspending the kettle assembly close to the ceiling and near the middle of the cavity, also tends to make it difficult for an operator to reload the kettle assembly with fresh cooking oil and corn to repeat the popping process. Reaching into the machine when surfaces may be hot, and manipulating the lid of the kettle assembly and the containers that hold the contents to be added to the kettle assembly, can be awkward and potentially hazardous, if an operator is not particularly attentive and careful.

An additional issue may arise when an operator experiences a problem with a kettle assembly that loses its ability to heat the oil and corn. An electrical malfunction or failure may be related to failure of a fuse, fusible link or thermostat within a kettle assembly. Kettle assemblies generally have an inner bowl that is located within an outer bowl. A heating element is connected to the bottom of the inner bowl and there may be a fuse or fusible link and a thermostat connected within hardwiring of the kettle assembly between the heating element and a power cord that extends from the kettle assembly and terminates in a plug. The plug is configured to be plugged into a socket located in the bottom surface of the upper unit, or ceiling, with the socket being hardwired to a machine controller. When experiencing an electrical malfunction within a kettle assembly, such as a burned out fusible link or thermostat, there typically is no provision for disassembly to readily access and replace electrical components. Thus, such a failure commonly results in the need to replace the entire kettle assembly, even though the vast majority of the kettle assembly components otherwise would continue to be in useful condition. The need to replace an entire kettle assembly not only presents a cost issue for an operator, but also a convenience issue because a new kettle assembly must be ordered and delivered, before the popcorn machine can be used again.

The above-mentioned types of shortcomings of popcorn machines have been present for years, as the machines have seen very little innovation, other than in larger commercial machines that are used to support vending services. Indeed, even aspects relating to ornamentation of popcorn machines generally have not changed in years. For instance, when one looks at lighting, it is still common to have a simple light bulb mounted to or located within the bottom surface of the upper unit, shining downward to light the cavity of the housing. Optional other lights may be used for ornamentation, such as by having lit bare bulbs completely above the cavity and extending from outer side surfaces of the upper unit, or the upper unit may incorporate more traditional lighted signage. These types of lighting schemes are quite common, have been used for decades, and for this reason do not tend to attract the attention desired.

The popcorn machines of the present disclosure address many of the aforementioned shortcomings, while providing advantages that enhance numerous aspects associated with shipping, assembling, operating and servicing popcorn machines.

### SUMMARY OF THE INVENTION

The purpose and advantages of the disclosed subject matter will be set forth in and apparent from the description and drawings that follow, as well as will be learned by practice of the claimed subject matter.

The present disclosure generally provides popcorn machines and presents modular constructions that permit lower costs and ease of shipping of popcorn machines in a less than fully assembled state. The unique configurations of popcorn machines disclosed herein permit shipping of popcorn machines having modular components that require modest assembly by a customer. Thus, instead of experiencing the aforementioned disadvantages of shipping a fully assembled popcorn machine, having potential increased costs associated with shipping and damage during shipment, the popcorn machines of the present disclosure are intended to be shipped in a manner that will enable relatively quick and easy assembly by a purchaser that takes delivery of a machine. Thus, modular components can be grouped in higher density configurations in one or more containers, to reduce the risk of breakage of side panels, and to reduce the cost and difficulty associated with shipping a single very large container that holds a fully assembled machine. For instance, modular components may be grouped in two or more containers that individually are of smaller size and weight, thereby reducing freight charges and avoiding costs associated with requiring a truck with a lift for delivery. The modular components may be constructed for relatively quick and easy assembly of a popcorn machine, and in some constructions may offer tool-free assembly.

The present disclosure also addresses shortcomings of the prior art in numerous other constructions. For instance, the disclosure includes numerous advantageous housing constructions that would be highly beneficial when an operator seeks to clean the inside of a popcorn machine or in settings where it would be advantageous to be able to access the inside of the housing of a popcorn machine from more than one side. These advancements include constructions that permit additional side panels to be temporarily opened or removed for improved access to the cavity inside of a machine, as well as to the inward facing surfaces of the side panels. Additional constructions are disclosed that allow the kettle assembly supports to be removed or pivoted out of the way to better accommodate reaching through a machine when cleaning.

Further advancements are disclosed with respect to constructions that enable an operator to influence the direction of the air flow vented from the cavity of the popcorn machine to disperse the enticing smell of the popped corn. These constructions also permit filtering of the vented air and/or the addition of a scent to the air stream, such as to supplement the smells that are generated during popping of the corn, or to continue to provide the smell of freshly popped corn even after popping has concluded.

Advantageous structures also are disclosed with respect to the use, cleaning and servicing of kettle assemblies. With respect to the ease of adding corn and oil products to a kettle assembly for popping, constructions are disclosed that permit an operator to gain enhanced access from above the opening of the kettle assembly. These constructions include utilizing one or more structural enhancements that permit an operator to lower the kettle assembly, to rotate the kettle assembly toward the operator, and/or to slide the kettle assembly outward from the housing of the machine toward the operator.

With respect to cleaning kettle assemblies, constructions are disclosed that offer an operator an opportunity to separate components of the kettle assembly for ease of cleaning, such as via removal of the lid from the bowl assembly. Still further advantageous constructions are disclosed with respect to servicing kettle assemblies, such that an operator is permitted an opportunity to open a kettle assembly and reset or replace faulty or failed electrical components, instead of having to expend the time and cost to order and replace the entire kettle assembly.

The present disclosure also presents advantageous constructions that address lighting aspects that permit personalization of a machine and/or may enhance the ability of a popcorn machine to attract attention. Such constructions include lighting fixtures that do not simply shine a bulb within the housing to light the cavity where the corn is popped and temporarily stored, but rather present an integrated way of edge lighting one or more side panels by providing a light source that shines through one or more edges of a side panel. Aside from providing a side panel that may exhibit a glow that can include colored light, the effect of the edge lighting can be enhanced by including etching on the side panel, which causes the etched indicia to appear to be more substantially illuminated. This can be particularly advantageous when a purchaser of a machine would like to personalize the machine, such as by highlighting a family or company name.

Many of the aforementioned advantageous constructions may be incorporated together into original equipment popcorn machines. Some additionally may be utilized in an aftermarket manner, such as by incorporation into a kit for adaptation to existing machines.

In a first aspect, the disclosure presents a popcorn machine that includes an upper unit spaced from and above a base unit, a plurality of columns being spaced apart and slidably connected to the upper and base units thereby defining a cavity, at least three side panels that extend within the respective spaces located between the upper and base units and between spaced apart columns, a kettle assembly positioned within the cavity, a first side of the popcorn machine having an opening through which the cavity is accessible, and at least a second side of the popcorn machine having an opening through which the cavity is accessible.

In another aspect, the disclosure presents a side panel for a popcorn machine that includes at least one transparent portion, a first vertical rail that is connected along an edge of the at least one transparent portion and further includes a portion of a hinge that is configured for pivotal connection to the popcorn machine, a second vertical rail that is connected along an opposed edge of the at least one transparent portion and that further includes a latch, and wherein the latch is movable between a locked position and an unlocked position.

In a further aspect, the disclosure presents a popcorn machine that includes at least one side panel having edge lighting that includes an upper unit spaced from and above a base unit, a plurality of columns being spaced apart and connected to the upper and base units, at least three side panels that extend within the respective spaces located between the upper and base units and between spaced apart columns, at least one of the side panels further including a transparent portion and having a channel connected to an edge of the transparent portion, and a lighting element configured to be located within the channel and to shine light through the edge of the transparent portion of the side panel.

Thus, the present disclosure presents alternative constructions and configurations for popcorn machines that overcome many of the shortcomings of the prior art. Many of the teachings herein address aspects of prior art popcorn machines that have made such machines problematic for shipping or more difficult to use, to clean or to service, than desired.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a perspective view of an assembled popcorn machine.

FIG. 2 is a partially exploded perspective view of the popcorn machine of FIG. 1.

FIG. 3 is a further partially exploded perspective view of components that are positioned between the base unit and upper unit of the popcorn machine of FIG. 1.

FIG. 4 is a top partial cross-sectional view of the side panels and columns of the popcorn machine of FIG. 1, taken just above the connection of the side panels to the columns.

FIG. 5 is a partial cross-sectional perspective view of a pivotal side panel and a column of the popcorn machine of FIG. 1, and showing a lighting strip for the transparent side panel, with the side panel being located in the rear of the popcorn machine of FIG. 1.

FIG. 6 is a front plan view of a latch of the popcorn machine of FIG. 1, shown in a latched position, as well as in a hidden, raised, unlatched position.

FIG. 7 is a top partial cross-sectional view of the latch of FIG. 6, showing the whole latch in the latched position with the side panel substantially coplanar with a portion of a column, in a closed position, and in cross-section.

FIG. 8 is a top partial cross-sectional view of the latch of FIGS. 6 and 7, showing the whole latch in the raised unlatched position, with the side panel pivoted away from the portion of the column, toward an open position, and in cross-section.

FIG. 9 is a partial cross-sectional exploded perspective view of a portion of the upper unit of the popcorn machine of FIG. 1, showing a rotatable venting assembly.

FIG. 10 is a partial cross-sectional perspective view of a sidewall of the rotatable venting assembly of FIG. 9.

FIG. 11 is a partial cross-sectional exploded perspective view of a portion of an upper unit of a popcorn machine, showing an alternative rotatable venting assembly.

FIG. 12 is a partial cross-sectional perspective view of the upper unit and alternative rotatable venting assembly of FIG. 11.

FIG. 13 is a partially exploded perspective view of a removable side panel and column, with the side panel being of the type located on the left and right sides of the popcorn machine of FIG. 1, and the column being shown in partial cross-section taken along the top and bottom of the removable side panel.

FIGS. 14 and 15 are cross-sectional views showing the movements of the removable side panel used to connect the removable side panel to the column of FIG. 13.

FIG. 16 is a perspective view of a wired column of the popcorn machine of FIG. 1 showing one way of facilitating electrical connection of a base unit to an upper unit.

FIG. 17 is an upper perspective view of the kettle assembly of the popcorn machine of FIG. 1.

FIG. 18 is a partially exploded upper perspective view of the kettle assembly of FIG. 17, with the kettle closure assembly released from and raised above the joined inner and outer bowls of the popcorn machine of FIG. 1.

FIG. 19 is a partially exploded upper perspective view of the kettle assembly of FIG. 17, with the kettle closure assembly released from and raised above the inner bowl, and the inner bowl released from and raised above the outer bowl of the popcorn machine of FIG. 1.

FIG. 20A is a lower perspective view of an electrical element connected to a portion of the bottom of the inner bowl of the kettle assembly of FIG. 17.

FIG. 20B is a partially exploded lower perspective view of the electrical element and connecting hardware shown in FIG. 20A.

FIG. 21 is a partial cross-sectional view of the electrical element shown in FIG. 20A removed from the connecting hardware on the inner bowl of the kettle assembly of FIG. 17.

FIG. 22A is a partial cross-sectional front perspective view of one side of the kettle assembly of FIG. 17 resting on a removable kettle support that is removably connected to a coupling portion of the upper unit of the popcorn machine of FIG. 1.

FIG. 22B is a perspective view of the removable kettle support and coupling portion of the upper unit of the popcorn machine of FIG. 1.

FIG. 23 is an exploded perspective view of the removable kettle support of the popcorn machine of FIG. 1, with an alternative coupling portion of an upper unit of a popcorn machine.

FIG. 24 is a partial cross-sectional front perspective view of one side of the kettle assembly of FIG. 17 resting on an alternative removable kettle support, with a further alternative coupling portion of an upper unit of a popcorn machine.

FIG. 25A is an upper perspective view of an alternative pair of removable and height adjustable kettle supports, with a further alternative coupling portion of an upper unit of a popcorn machine.

FIG. 25B is a side view of the adjustment mechanism for the removable and height adjustable kettle supports of FIG. 25A.

FIG. 26 is an exploded perspective view of an alternative foldable kettle support bracket having an alternative coupling portion for connection to an upper unit of a popcorn machine.

FIG. 27 is a partially exploded upper perspective view of an alternative example popcorn machine showing portions of an upper unit, a base unit and columns therebetween, with a side panel that is configured to permit selective coupling of the side panel in a fixed position or in a pivotal position relative to one or the other of the columns.

FIG. 28 is an upper perspective cross-sectional view of a portion of one of the columns and adjacent side panels showing selective installation of coupling pins in the side panels for an example popcorn machine using the construction of FIG. 27.

FIG. 29 is a top plan view of the arrangement of side panels that would be pivotally coupled for an example popcorn machine using the construction of FIG. 27.

FIGS. 30-32 are partially exploded perspective views of selective alternative configurations for pin installations in side panels of an example popcorn machine using the construction of FIG. 27.

FIGS. 33-35 are top plan views of an example popcorn machine using the construction of FIG. 27 and showing advantageous selective pivotal coupling of side panels when placed in alternative service arrangements.

FIG. 36 is a front cross-sectional view of an alternative kettle assembly having a removable bottom portion of the outer bowl.

FIG. 37 is a partial cross-sectional upper perspective view of the outer bowl of the kettle assembly of FIG. 36 showing engagement of the removable bottom portion.

FIG. 38 is a further alternative column structure for an example popcorn machine having coupling portions that provide sleeves in the corners of the base unit and upper unit and inward facing spring locks to removably couple the column thereto.

FIG. 39 is a top plan view of the column and coupling portion of the upper unit of the example construction of FIG. 38 showing the location of a spring lock.

FIG. 40 is a partial cross-sectional view of a spring lock fastened to the column and engaging an aperture in a coupling portion of an upper unit of the example construction of FIG. 38.

FIG. 41 is a another alternative column structure for an example popcorn machine utilizing coupling portions that provide sleeves in the corners of the base unit and upper unit and outward facing spring locks to removably couple the column thereto.

FIG. 42 is a top plan view of the column and coupling portion of the upper unit of the example construction of FIG. 38 showing the location of a spring lock.

FIG. 43 is a partial cross-sectional view of a spring lock fastened to the column and engaging an aperture in a coupling portion of an upper unit of the example construction of FIG. 41.

FIG. 44 is a further alternative column structure for an example popcorn machine utilizing coupling portions that provide sleeves in the corners of the base unit and upper unit and threaded fasteners to join the column to the coupling portions of the base and upper units.

FIG. 45 is a top plan view of the column and coupling portion of the upper unit of the example construction of FIG. 44 showing the location of a threaded fastener.

FIG. 46A is a partially exploded upper perspective view of a portion of an upper unit of a popcorn machine and a pivotally mounted kettle support.

FIG. 46b is a partial cross-sectional side view showing the configuration of the components of FIG. 46A when the kettle support is connected to the upper unit of the popcorn machine.

FIG. 47 is a partially exploded upper perspective view of an alternative kettle support that includes removable and height adjustable kettle supports that also are connected to a track system that permits slidable movement relative to the upper unit of the popcorn machine.

It should be understood that the drawings are not to scale. While some mechanical details of a popcorn machines and other plan and section views of the particular components have not been included, such details are considered well within the comprehension of those of skill in the art in light of the present disclosure. It also should be understood that the claimed subject matter is not limited to the example embodiments illustrated.

### DETAILED DESCRIPTION OF THE PREFERRED EMBODIMENTS

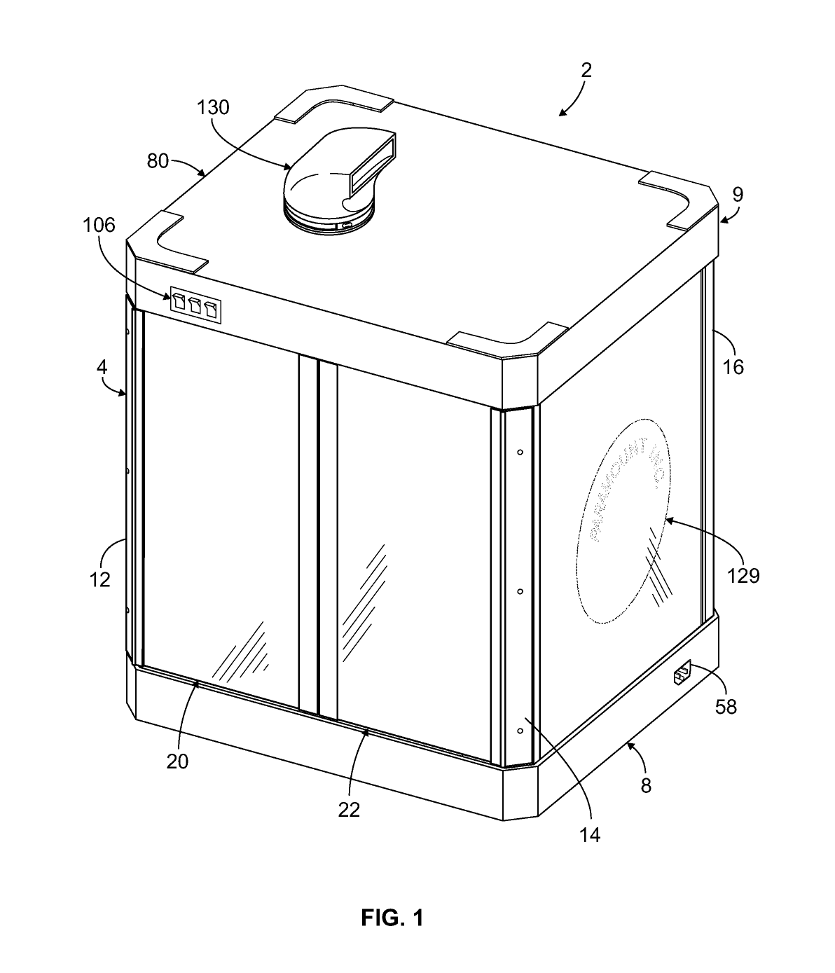

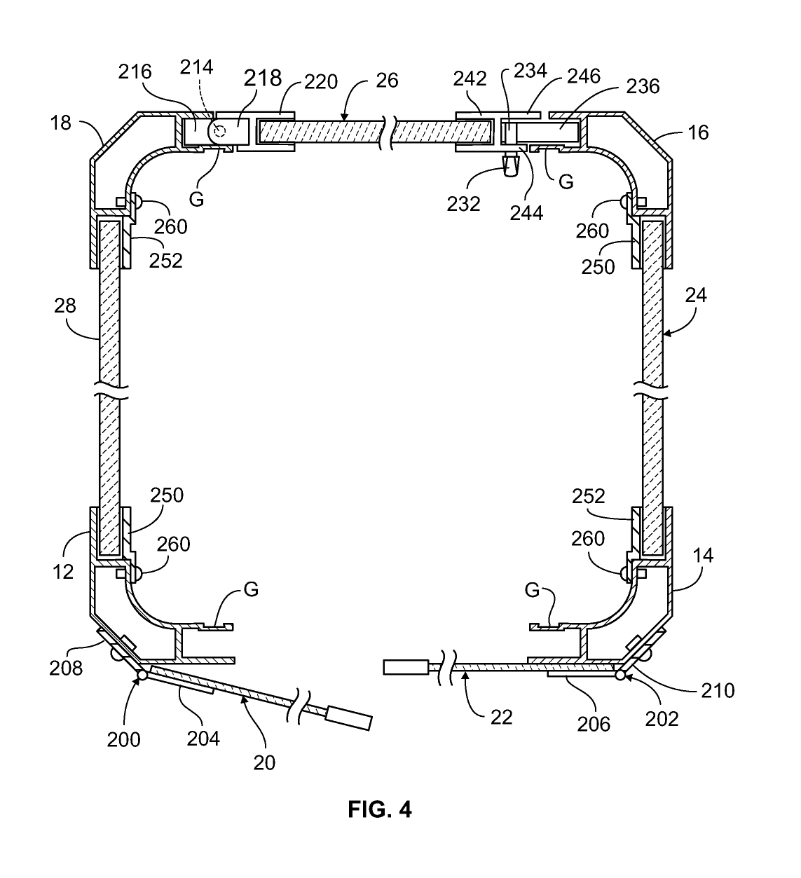

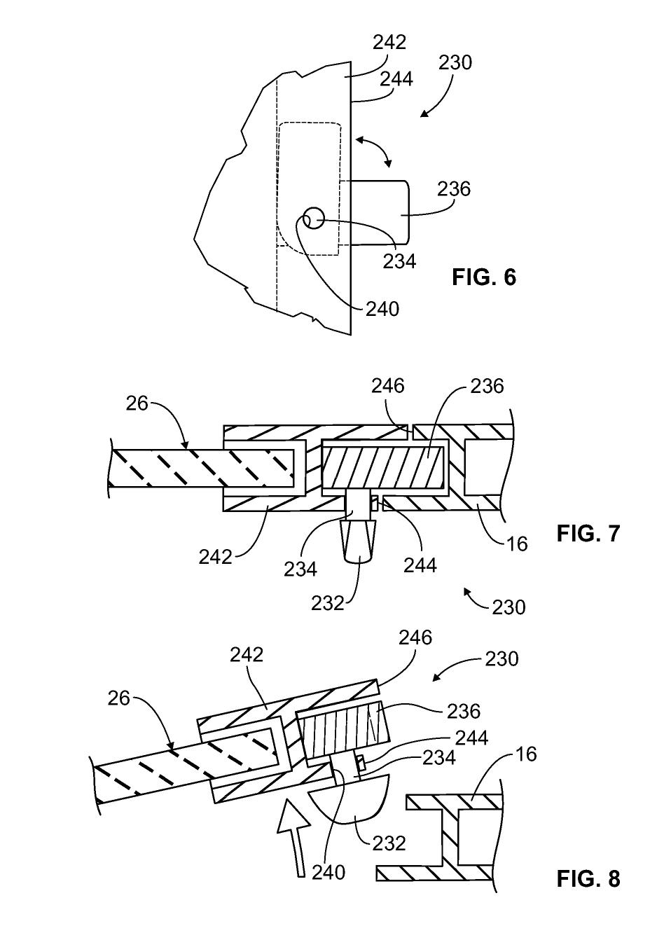

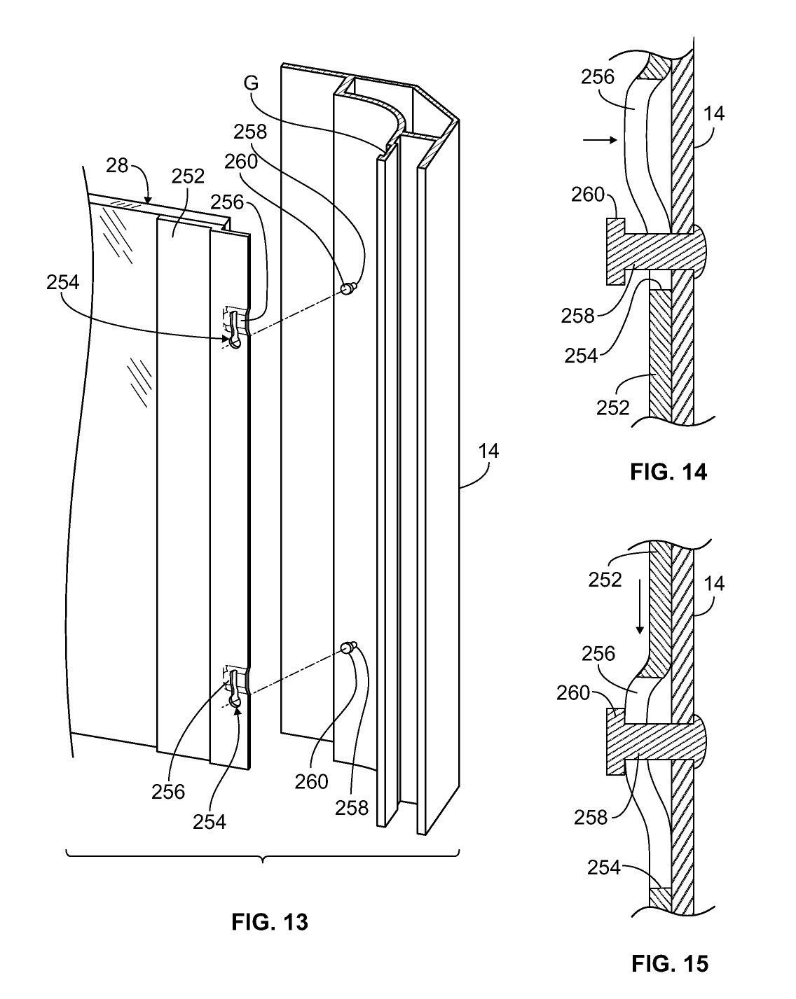

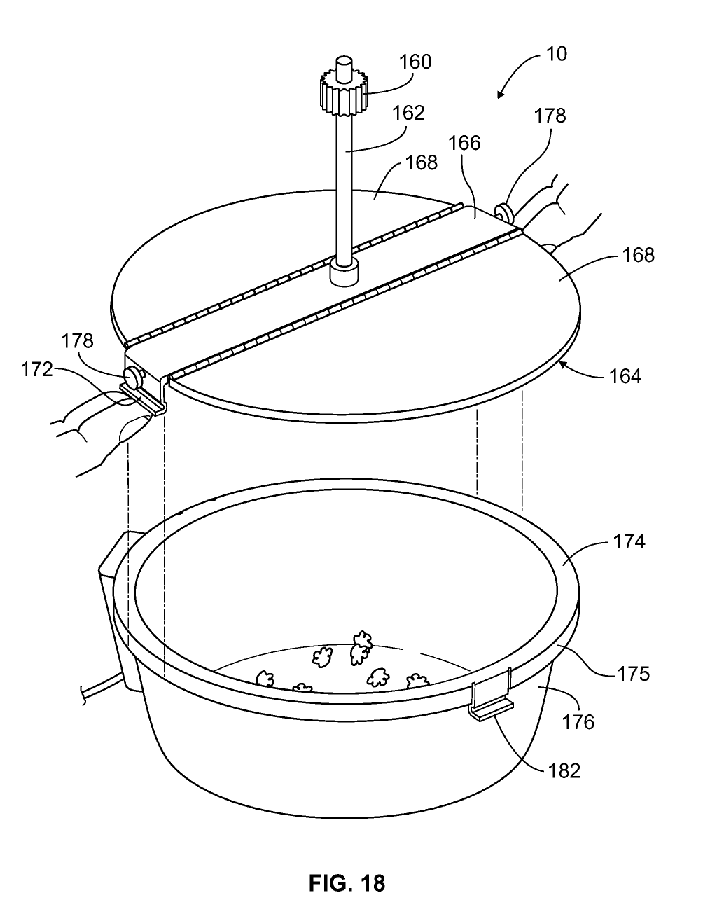

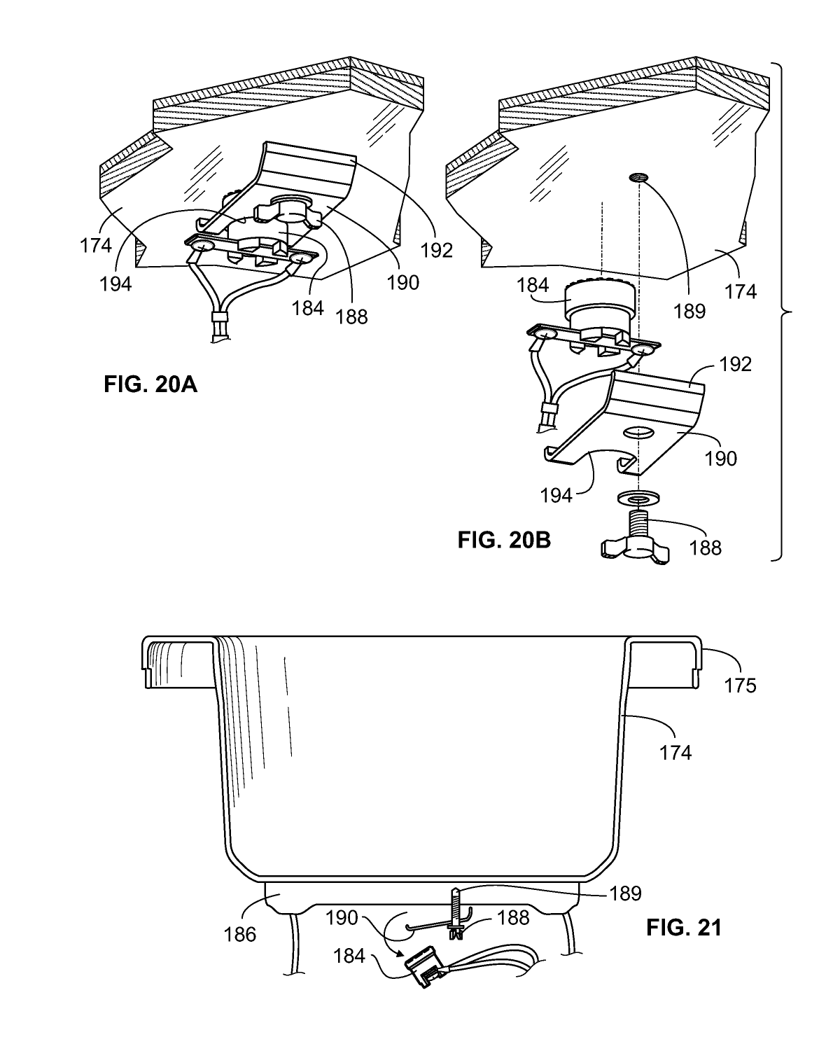

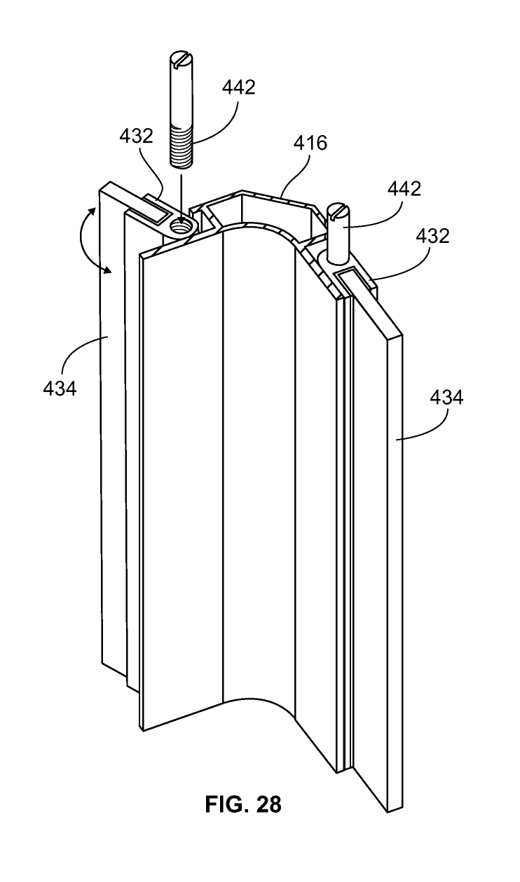

Referring generally to FIGS. 1-47, it will be appreciated that popcorn machines of the present disclosure generally may be embodied within numerous configurations, having one or more advantageous features relative to prior art machines. Indeed, while acknowledging that all example configurations that may include the various advantageous features of popcorn machines and methods of making and using such machines need not be shown herein, it is contemplated that popcorn machines may incorporate various combinations of the advantageous features taught herein. To demonstrate this position, the first example popcorn machine includes several, but not all, of the inventive features disclosed herein.

Turning to FIGS. 1-10 and 13-22B, a first example popcorn machine 2 is illustrated. The popcorn machine 2 includes a housing 4, defining a cavity 6. The housing 4 has a base unit 8 and an upper unit 9. The base and upper units may be made of suitable materials, which may include stamped steel, such as stainless steel, aluminum, plastics or any other materials that perform well in environments that are subjected to heat and food products. A kettle assembly 10, which typically is constructed of stainless steel, hangs from kettle supports 11, which also tend to be constructed of stamped steel or stainless steel that are connected to the upper unit 9. A plurality of columns 12, 14, 16, 18 extend vertically between and are coupled to the base unit 8 and upper unit 9, and in this example are shown as being located in the corners of the housing 4. Extending horizontally or laterally between the columns 12, 14, 16, 18 are side panels 20, 22, 24, 26, 28. Each of the side panels 20, 22, 24, 26, 28 preferably includes at least one transparent portion and may be constructed of a durable material that is suitable for contacting a food product, such as glass or plastic. However, it will be appreciated that any of the side panels in their entirety, or any portions thereof, may be non-transparent and may be constructed of glass, plastic or other suitable materials, such as aluminum, stainless steel, or the like. In this first example popcorn machine 2, all of the side panels include both a transparent portion and at least one non-transparent portion. All of the side panels also are vertically oriented, with some being pivotally connected along a vertical pivot axis, but it will be understood that popcorn machines could utilize side panels that close only a portion of a side of a machine and that are pivotally connected along a horizontal axis, such as may be known as a tilt out tray.

The two side panels 20, 22 are configured as doors pivotally connected to columns 12, 14, and the side panels 20, 22 together substantially close the front side of the housing 4. The side panel 26 is configured as a single door pivotally connected to column 18 and individually closes the rear of the housing 4, while each of the other side panels 24, 28 is configured to be a removable panel connected to a pair of columns 14, 16 and 12, 18, respectively, and they each individually close a side of the housing 4. It will be appreciated that popcorn machines could be in configurations other than rectangular, that a different number of columns and side panels could be used, and that not all columns must be located in a corner, as a column could be located along a side, such as to permit use of two narrower side panels in place of what would otherwise require one larger side panel.

The base unit 8 of this example popcorn machine 2 may include a body 30 having a lower pan 32 formed with upstanding walls 34, 36, 38, 40. The corners of the base unit 8 may include lower couplings 42, 44, 46, 48 that are fixedly connected to the lower pan 32, such as by welding, rivets or other suitable means of attachment, or are otherwise incorporated into the body 30. The lower couplings 42, 44, 46, 48 also are configured for slidable connection to respective columns 12, 14, 16, 18. In this example, an inner surface of at least the lower end of each column 12, 14, 16, 18 has a shape that includes at least one undercut groove G that slidably mates with at least one undercut tail T extending from an outer surface of a lower coupling, in somewhat of an undercut or dovetail manner. This slidable mating structure provides an example of at least one form of a sleeved fit that joins and locates the components laterally with respect to each other. Other alternative slidable configurations are contemplated, including structures having a portion of one component slidably received within another component, so as to have the entire perimeter of the portion of the one component surrounded by the other component.

To lock each column vertically relative to a lower coupling of the base unit 8, each column of this example has a spring lock 50 fixedly connected thereto at a lower end, and each spring lock 50 has a post 52 that engages an aperture 54 in a lower coupling. Thus, during assembly of the popcorn machine 2, the base unit 8 is placed on a surface, such as a table top or the ground, and each column 12, 14, 16, 18 is separately connected to the base unit 8 by being slid downward into mating engagement with a respective lower coupling 42, 44, 46, 48 until the column reaches the lower pan 32. When the lower end of the column contacts the lower pan 32, the post 52 of the spring lock 50 is biased to enter the aperture 54 in the lower coupling, locking the components together to resist inadvertent relative vertical movement. It will be appreciated that the spring lock 50 and post 52 may be configured to audibly snap into place when received within an aperture 54, to confirm a successful connection. In any event, the post 52 will be visible within the aperture 54 when in the locked position, thereby providing visual confirmation of a successful connection. This arrangement provides for quick, easy and tool-free locking connection of the columns 12, 14, 16, 18 to the base unit 8, leaving the columns perpendicular to the broad expanse of the lower pan 32, and parallel to the upstanding walls 34, 36, 38, 40. It will further be appreciated that tool-free connection could be established by use of alternative configurations for spring locks, such as a biased pushbutton, or other suitable constructions. Moreover, locking connection could be made with minimal use of tools, whether by a fixed connection, such as by use of one or more rivets to connect each column to each upper and lower coupling, or by removable connection, such as by use of a removable fastener in the form of a screw or other suitable fastener.

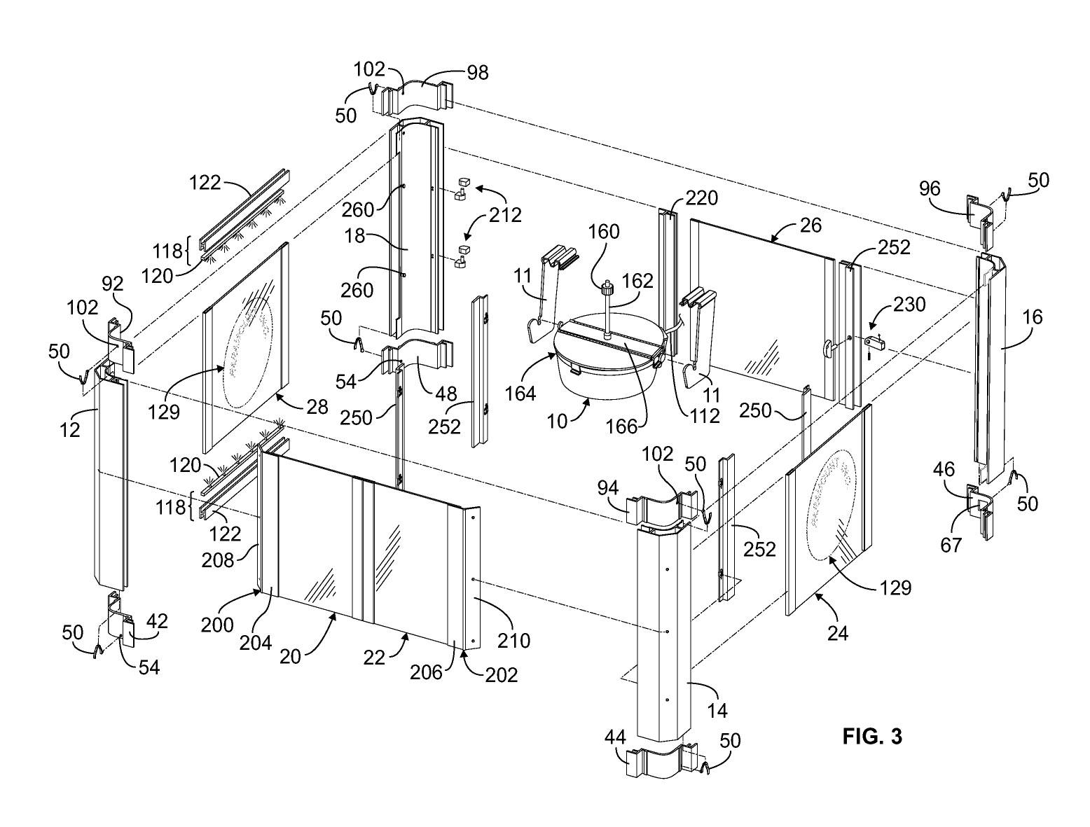

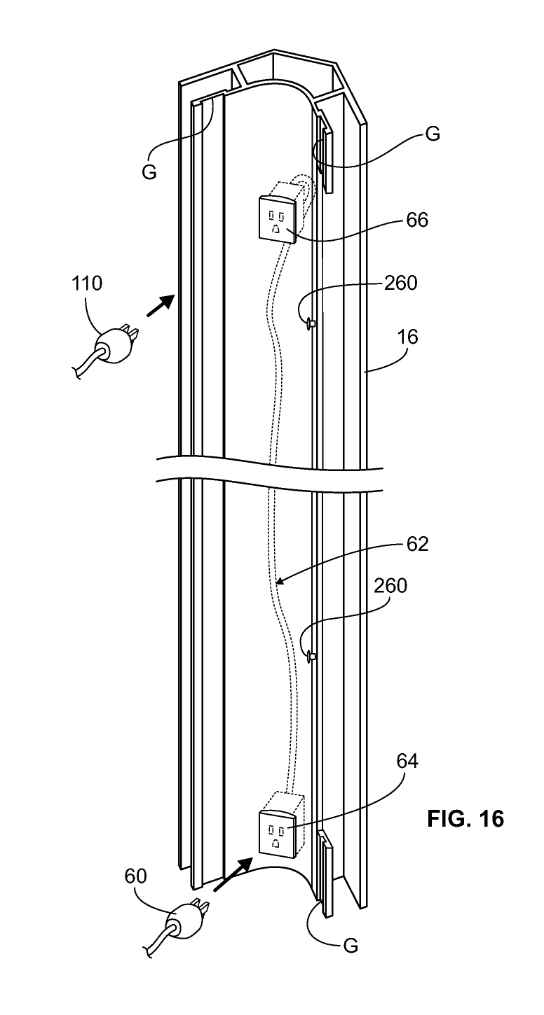

Disposed within the base unit 8 is a power junction box 56 that is connected to the lower pan 32 of the body 30, such as by screws or other suitable fastening means that may permit removal of the power junction box. The power junction box 56 also provides a socket 58 that is accessible through an aperture in the upstanding wall 36 of the body 30 of the base unit 8. The socket 58 is adapted for connection to an external input power cord that would be used to connect the popcorn machine 2 to a wall socket to provide an electrical power input to the popcorn machine 2. In this example, the power junction box 56 also has an output power cord 60. As may be seen in FIG. 16, the output power cord 60 is configured to be plugged into a wiring harness 62 at a first socket 64 that is mounted in the lower end of the corner column 16, so as to bring power to the upper unit 9, via a second socket 66. The output power cord 60 is shielded from the cavity 6 of the popcorn machine 2 by the upper pan 72 of the base unit 8, and plugs into the socket 64 through an aperture 67 in the lower coupling 46, which may be seen in FIG. 3. The second socket 66 near the upper end of the column 16 is located within the cavity 6 for connection to electrical components in the upper unit 9. It will be appreciated that an external input power cord alternatively could be directly associated with the upper unit 9 or could enter the housing directly, without use of a socket.

In addition, the wiring harness in the column 16 may include sockets or plugs or a combination thereof at its ends and one or both ends may be located within the column or extend beyond the column and into the upper unit and/or the base unit. Any of these configurations are believed to distinguish over the prior art popcorn machines that are hardwired throughout, other than for the typical receipt of a plug extending from a kettle assembly and to be received in a socket of the upper unit. Such machines are completely assembled at the manufacturer, as opposed to being shipped as a group of modular components that require some assembly of the machine after shipping.

The base unit 8 also includes a heating element 68 that is connected to the power junction box 56, which may include a thermostatic device for monitoring and controlling the warming level provided by the heating element 68. One or more stands 70, which could be formed of bent sheet metal, metal tubing or other appropriate materials, are connected to the lower pan 32 of the body 30, such as by use of welding, rivets or other suitable means of fastening. The base unit 8 also includes an upper pan 72 that removably rests atop the stands 70 and the power junction box 56. The upper pan 72 presents a broad top surface of the base unit 8 that functions as a floor of the cavity 6 and substantially closes the bottom of the housing 4 when the popcorn machine 2 is fully assembled. The upper pan 72 assists in dispersing and delivering the heat from the heating element 68 to warm popped corn that may rest on the upper pan 72, while being removable for cleaning and servicing purposes. In this example, the upper pan 72 of the base unit 8 optionally includes a plurality of apertures 74 that collectively form a rectangular pattern. The apertures 74 permit waste, such as unpopped kernels to pass through the upper pan 72 and into a drawer 76 that is slidably received in the body 30 of the base unit 8. The drawer 76 may be removed and emptied periodically, as desired.

The upper unit 9 of this example popcorn machine 2 may include a body 80 having a cover 82 formed with downward extending walls 84, 86, 88, 90. The corners of the body 80 have exterior surfaces extending downward and may include internal upper couplings 92, 94, 96, 98 that are shown in FIG. 3 apart from the cover 82, but it will be understood that the upper couplings are fixedly connected to the cover 82, such as by welding, use of rivets or other suitable means of attachment, or which may otherwise be integrated into the cover. The cover 82 also is effectively closed in the downward direction when the popcorn machine 2 is assembled by a ceiling panel 100 that is connected to the body 80, preferably by removable fasteners, such as screws that are not shown for convenience. The ceiling panel 100 serves as the ceiling of the cavity 6 of the housing 4.

In this example, as with the lower couplings, the upper couplings 92, 94, 96, 98 also are configured for slidable connection to the respective columns 12, 14, 16, 18. Accordingly, an inner surface of at least the upper end of each column 12, 14, 16, 18 has a shape that includes at least one undercut groove G that slidably mates with at least one undercut tail T extending from an outer surface of an upper coupling, in somewhat of an undercut or dovetail manner. As with the lower couplings, this provides a form of a sleeved fit at the upper ends of the columns that locates the components laterally relative to each other, and alternative slidable configurations could be used, such as by including structures having a portion of one component slidably received within another component, so as to have the entire perimeter of the portion of the one component surrounded by the other component.

To connect the upper unit 9 to the columns 12, 14, 16, 18 and lock it in place, the upper unit 9 is raised to be in vertical alignment with the vertically extending columns 12, 14, 16, 18 that have been connected to the base unit 8 that is resting on a surface, and the upper unit 9 is then lowered so as to have the upper couplings 92, 94, 96, 98 that are fixedly connected to the cover 82 of the upper unit 9 slidably engage the respective columns 12, 14, 16, 18. As the upper unit 9 is lowered toward the base unit 8, the upper ends of the columns achieve mating engagement with the upper couplings and contact the cover 82. When the upper ends of the columns contact the cover 82, the posts 52 of the spring locks 50 are biased to enter the apertures 102 in the upper couplings, locking the components together to resist inadvertent relative vertical movement, and forming the assembled housing 4. As noted with respect to assembly of the base unit 8 to the columns 12, 14, 16, 18, the spring locks 50 may be configured to audibly snap into place when the posts 52 are received within the apertures 102, to confirm a successful connection, and the presence of the posts 52 within the apertures 102 will provide a visual confirmation of a successful connection. This arrangement provides for quick, easy and tool-free locking connection of the upper unit 9 to the columns 12, 14, 16, 18, which previously were connected in a somewhat similar manner to the base unit 8. To provide a finished look and still permit access to the spring clips for disassembly of the upper unit 9 from the columns 12, 14, 16, 18, each corner of the cover 82 is fitted with a removable cap 104. The caps 104 may include downward extensions that engage the top of the columns or upper couplings for retention purposes.

Disposed within the upper unit 9 is a control panel 106, which is electrically connected to an outlet box 108 having two sockets (not shown). A first socket receives a plug of an input power cord 110 that is plugged into and extends from the second outlet 66 of the wiring harness 62 that is mounted in the upper end of the column 16. A second socket of the outlet box 108 receives a plug of a power cord 112 for the kettle assembly 10. The control panel 106 typically will include switches and/or indicator lights 114 relating to control and operation of components of the popcorn machine 2, such as the heating element 68 in the base unit 8, a fan 116 and a motor 117 in the upper unit 9, the kettle assembly 10 within the cavity 6 of the housing 4, and/or of one or more optional lighting fixtures 118.

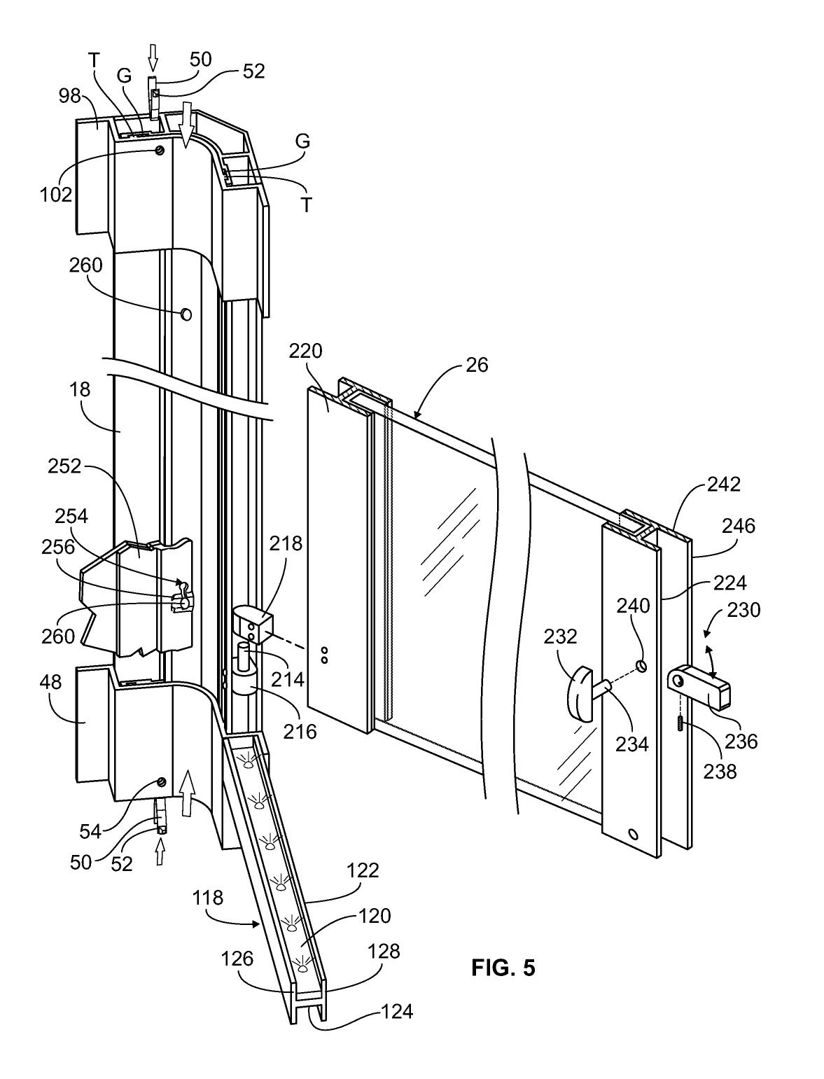

While the popcorn machine 2 may include a more traditional lighting fixture in the upper unit that would receive a bulb to shine directly downward into the cavity of the housing to light and potentially warm the cavity, in the example shown, advantageous new lighting fixtures are employed. Each lighting fixture 118 includes a lighting element 120, shown, for example, in the form of an LED light strip that is fitted within a channel 122. As may be seen in FIGS. 3 and 5, the example channel 122 has an H-shaped cross-section with a central web 124 extending between and being connected to opposed first and second upright walls 126, 128. This configuration permits the LED light strip 120, or other light source, to be placed on a first side of the central web 124 immediately adjacent a top and/or bottom edge of a transparent side panel, and to illuminate the side panel by shining light through the side panel, parallel to and within the plain of the side panel, in a manner much like the use of fiber optics. It will be appreciated that such new light fixtures of this type could be configured in many ways to provide edge lighting of a side panel, for example by connection to any of a one or more of a top, bottom and/or side edges of a side panel. This structure provides an edge lighting configuration that presents a particularly advantageous way to personalize a popcorn machine. For instance, transparent side panels may be treated to have etched indicia, such as the designs or logos 129 shown on the side panels in FIGS. 1-3, which will be particularly noticeable and appear to be directly illuminated when applying this lighting technique that shines light throughout the body of a panel. Etching to produce indicia on at least one surface of a transparent portion of a side panel may be accomplished in any conventional manner, such as by laser, chemical, sandblasting, grinding or other suitable methods.

It will be appreciated that the H-shaped channel configuration is able to receive and conceal electrical wiring on the opposed side of the web. Also, the central web 124 could include apertures, which would permit a lighting element 120, such as the light strip, to be located on the opposed side of the central web 124, so as to have the web disposed between the lighting element and the transparent side panel. The channel 122 also is configured to receive wiring for the LED light strip that ultimately can be connected to the control panel 106 via initially routing such wires upward into the upper unit, downward into the base unit, or to the sides into or along one or more of the columns, as needed. The lighting for the popcorn machine may incorporate one or more such lighting channels along top, bottom and/or side edges of a transparent portion of a side panel, or may be of a more traditional arrangement involving a bulb shining directly downward into the central portion of the cavity from a fixture in the upper unit 9.

The fan 116 of this example popcorn machine 2 includes an advantageous venting assembly 130, which may be seen at least in part in FIGS. 1, 2 and 9-10. The venting assembly 130 includes a tube 132 that is in communication with the fan 116 and the cavity 6, and which in this example is a rotatable tube that engages a housing 134 of the fan 116 when positioned through an aperture 136 in the cover 82 of the upper unit 9. In this example, the tube 132 includes an upper end having a larger diameter that provides an inner ledge 138 on which a nozzle 140 rests. The nozzle 140 of the venting assembly 130 in this example includes a bend and a flattened or rectangular outlet 142, permitting the air flow through the nozzle 140 to be directionally aimed, to best suit the arrangement of the popcorn machine 2 within its room or environment.

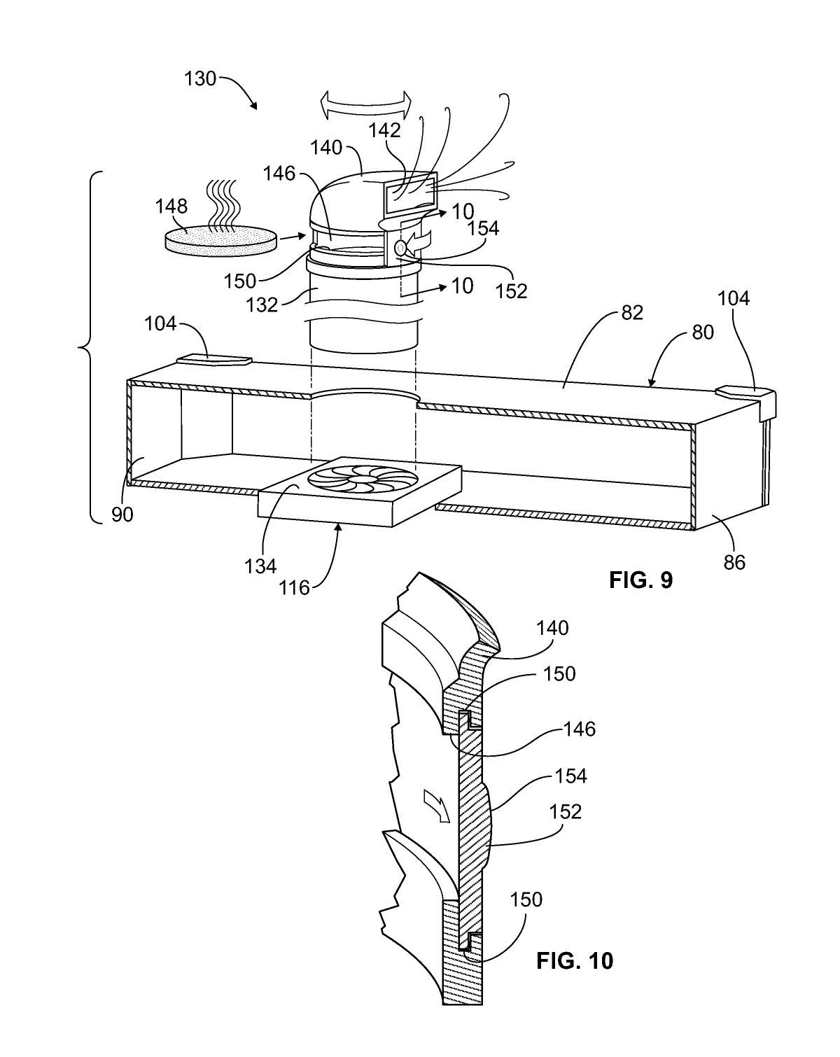

The ledge 138 in the tube 132 permits an insert 144, such as a filter element, to be placed on the ledge 138, between the tube 132 and the nozzle 140. In light of the desirability to generate the smell of freshly popped corn to entice patrons, the insert 144 alternatively may be a scented element, such as a scent infused or soaked fibrous pad. Use of such a scented element enables air being vented from the popcorn machine 2 to absorb a scent, so as to continue to spread desirable smells via the pressurized air, even when the kettle assembly 10 is not popping corn. As may be seen in FIGS. 9-10, the nozzle 140 also may include an opening 146 in its sidewall through which a second insert 148 may be received. The opening 146 of this example includes a slotted track 150 in the sidewall and may be closed by moving a door 152 that cooperatively slides within the track 150 in the sidewall of the nozzle 140. The door 152 may be pushed or pulled toward an open or closed position by grasping or pushing on a door handle 154, shown in the form of a protrusion extending from the door 152. It will be appreciated that a door may alternatively be configured for pivotal connection, or another suitable configuration that provides closable access to the inside of the nozzle 140. The nozzle alternatively may include the tube and filters or other scented elements may be located below the tube. Also, the venting assembly 130 may be used without any inserts, may be used with either of the inserts 144, 148 alone, or two or more inserts may be used together. Moreover, one or more of the inserts may be a filter element and/or a scented element, to assist in conditioning the air of the environment around the popcorn machine, as desired.

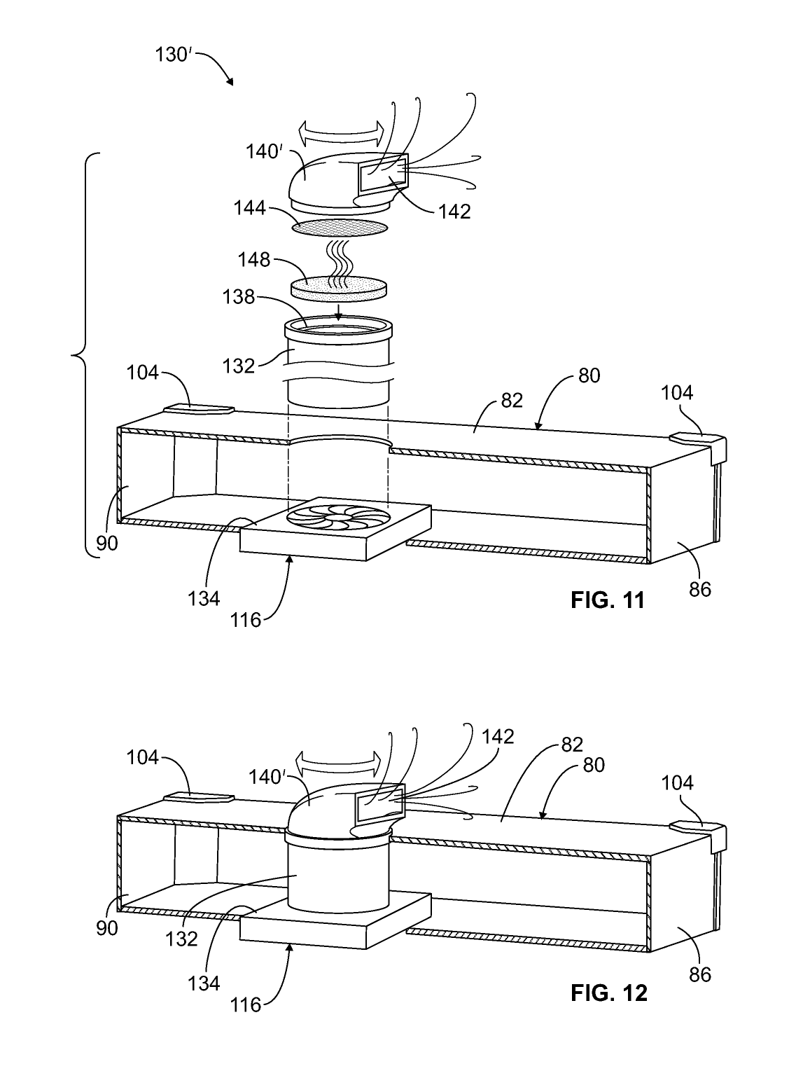

An alternative venting assembly 130′ is shown in FIGS. 11 and 12, which is a somewhat simplified version of the venting assembly 130. For instance, the example assembly still includes a rotatable tube 132 that engages a housing 134 of the fan 116 when positioned through an aperture 136 in the cover 82 of the upper unit 9. In this example, the internal ledge 138 is shown supporting the first insert 144 and the second insert 148, directly on top of each other. A simplified example nozzle still includes a bend and a flattened or rectangular outlet 142′, permitting the vented air to flow through the nozzle 140′ to be directionally aimed, as with the earlier described nozzle 140. However, the nozzle 140′ does not include an opening in its side, a track, or a movable door to close such an opening, as in the prior example. Thus, as with the prior example, the venting assembly 130′ may be used without inserts, or with one or more inserts that may include filter elements and/or scented elements that may be located within the air flow stream, anywhere between the cavity and the outlet, and may be used to condition the air to provide desirable smells via the pressurized venting air, even when the kettle assembly 10 is not popping corn.

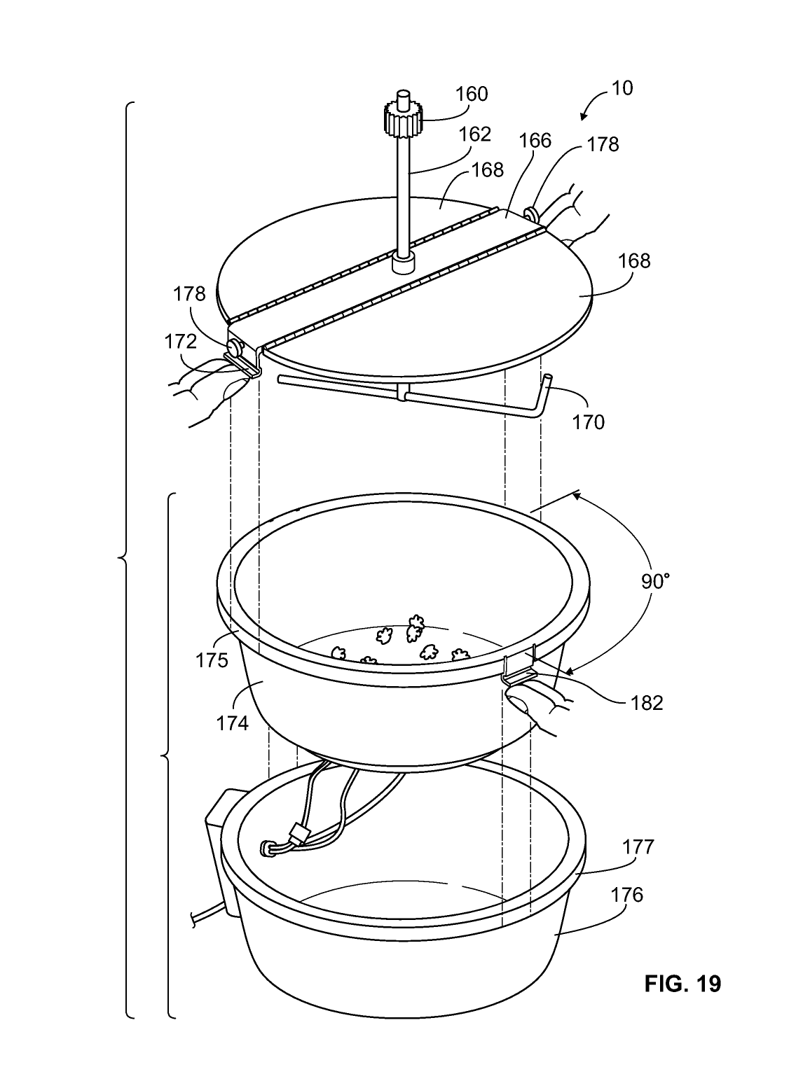

The motor 117 is connected to the ceiling panel 100 and includes a driven shaft having a gear (not shown) which extends through an aperture in the ceiling panel 100 in a conventional manner. The shaft and gear of the motor are used to drive a gear 160 on a shaft 162 that extends vertically upward from a kettle closure assembly 164 that is part of the kettle assembly 10. The kettle closure assembly 164 further includes a central mounting panel 166, a pair of lids 168 that are pivotally connected to the central mounting panel 166, and the shaft 162 extends downward through the central mounting panel 166 and carries an optional stirring implement 170 at its lower end. The stiffing element 170 may be a wire fixedly connected to the lower end of the shaft 162, as may be seen in FIG. 19, or a suitable alternative extension from the shaft 162 that is capable of stirring the contents within the kettle assembly 10.

It is believed that there are various prior art kettle assemblies that include a kettle closure assembly having a central mounting panel, a pair of lids pivotally connected to the central mounting panel and a stirring element on a shaft having a gear that is driven by a motor. Such prior art kettle assemblies generally include inner and outer bowls having electrical components mounted therebetween, and being fixedly connected to each other and to the central mounting panel, such as by use of nut and bolt or rivet fasteners, without the intention of separating those components, or focusing on separation of the central mounting panel from the inner and outer bowls. However, such constructions present difficulties for operators relating to trying to clean and service such kettle assemblies. The pivotal lids cover less than half of the opening of the upper end of the bowls and, as such, make it difficult to reach inside of the kettle assembly to clean the inward facing surfaces of the inner bowl and of the kettle closure assembly.

The kettle assembly 10 of the present disclosure provides several advantages relative to such prior art devices. For instance, as may be seen among FIGS. 3 and 17-21, the central mounting panel 166 includes at least one clip 172 that is biased to hold the kettle closure assembly 164 on the top of an inner kettle bowl 174 by engaging a rim 175 of the inner bowl 174. While one clip 172 could be used to establish connection, a pair of clips 172 is used in this example. The inner bowl 174, in turn, extends within an outer kettle bowl 176. A pair of posts 178 also is connected to the central mounting panel 166 to permit the kettle assembly 10 to hang from the kettle supports 11. In this example, the clips 172 are integrally formed as part of the central mounting panel 166, which preferably is constructed of stainless steel or other suitable material, similarly to the inner and outer bowls 174, 176. However, it will be appreciated that the clips alternatively could be separate components that are connected to the central mounting panel or to the inner and/or outer kettle bowl. In this example, the inner kettle bowl 174 includes at least one clip 182 that is biased to hold the inner kettle bowl 174 on top of the outer kettle bowl 176. While one clip 182 could be used to establish connection, a pair of integrally formed clips 182 is used in this example, with the clips 182 being biased to hold the inner kettle bowl 174 on top of the outer kettle bowl 176 by engaging a rim 177 of the outer bowl 176. It also will be appreciated that the clips 182 alternatively could be separate components that are connected to the inner and/or outer kettle bowl.

In this example, an operator may, by hand, conveniently force the clips 172 outward to release the central mounting panel 166, and therefore, the kettle closure assembly 164 from the inner bowl 174. This facilitates more complete cleaning of the kettle closure assembly 164 and the inner bowl 174. Additionally, contrary to prior art constructions, the biased clips permit convenient access to electrical components mounted between the inner and outer bowls. Thus, while failures of prior art kettle assemblies to provide heat for the cooking function did not permit easy servicing of electrical components or simply resulted in having to replace an entire kettle assembly, the kettle assembly 10 of the present disclosure permits an operator to easily separate the inner and outer bowls 174, 176 for servicing.

To take further advantage of the ability to separate the components of the kettle assembly 10, the present disclosure includes a configuration for mounting the body of an electrical element 184, such as a thermostat and/or fusible link, to the bottom of the inner kettle bowl 174, spaced from a kettle heating element 186 that in this example is of circular shape and is connected to the bottom of the inner bowl 174. In this example, the mounting of the electrical element 184 is by use of a threaded fastener 188 having a winged tool-free grasping end and a clamp plate 190. The clamp plate 190 includes a setoff 192 at a first end and a notch 194 at a second end that receives the electrical element 184. The threaded fastener 188 may be received in a threaded bore 189 of a plate fixed to the bottom of the inner bowl 174 or for instance to a threaded bore of a nut that has been fixed to the bottom of the inner bowl 174, such as by welding. It will be appreciated that the fastener components could be reversed so that the graspable fastener 188 includes a threaded bore and a threaded post is fixed to the bottom of the inner bowl 174, or that suitable alternative means of fastening could be used. The use of a fastener 188 permits an operator to quickly release the electrical element 184 from the inner bowl 174 for resetting, otherwise servicing or replacing the electrical element 184, with ease of reassembly of the electrical element to the inner bowl 174. Wires may be connected to the electrical element 184 by plug-in configurations or by use of other fasteners, such as threaded screws or the like. When the electrical element 184 has been reconnected to the bottom of the inner bowl 174, the operator may proceed with tool-free reconnection of the inner bowl 174 to the outer bowl 176, and the central mounting panel 166 to the inner bowl 174 by simply aligning these components and pressing them together vertically. This is conveniently facilitated by having the biased clips 172, 182 include draft angles along their length, which cause the clips to automatically flex outward when contacted by the rims of the inner and outer bowls, respectively, to accommodate connection by the biased clips 172, 182.

Turning to the construction, installation and operation with respect to the side panels 20, 22, 24, 26, 28, one will appreciate that each side panel may be pivotally or otherwise connected to a column, and may be easily removable. One or more hinged side panels may pivot about a vertical axis when connected to a column, although they may be combined with one or more additional panels that may be fixed in place or may be configured to pivot about a horizontal axis, such as would be provided with a tilt out tray. In the present example, side panels 20, 22 are shown as a pair of doors having transparent portions and respective hinges 200, 202 by which side panels 20, 22 may be pivotally connected to columns 12, 14. Hinges 200, 202 include first hinge plates 204, 206 that are may be connected to the transparent panels, such as by use of adhesive or other suitable fastening means, and second hinge plates 208, 210 that may be removably connected to columns 12, 14, such as by use of threaded fasteners or other suitable fastening means. The side panels 20, 22 may be connected to the columns 12, 14 upon manufacture and shipped in a connected condition, or if desirable for shipping or other purposes, the side panels 20, 22 may be assembled to the columns 12, 14 after delivery of the popcorn machine 2 and the aforementioned assembly of the base unit 8, upper unit 9 and columns 12, 14, 16, 18 via lower couplings 42, 44, 46, 48 and upper couplings 92, 94, 96, 98.

It also will be appreciated that alternative means of connecting hinge elements to the side panels and columns may be used, as well as alternative configurations for pivotally connecting side panels to columns. For example, an alternative construction is used with respect to pivotal connection of the side panel 26 to the housing 4. Hinges 212 are illustrated in FIGS. 3-5 with respect to the connection of the side panel 26 at the rear of the popcorn machine 2. The hinges 212 are of a type referred to as “lift off hinges” because the side panel 26 may be lifted upward to be removed, as such there are at least two hinges 212 and they include pins 214 that extend upward from collars 216 that are connected to column 18, such as by threaded fasteners or other suitable fastening means, and that are slidably received in vertically aligned bores (not shown) of complementary collars 218 that are connected to a vertical rail 220 having a channel that is connected to a transparent portion of the side pane 26, such as by use of adhesive or other suitable fastening means.

Along the opposed vertical edge of the side panel 26 is a latch 230, which may be seen in FIGS. 5-8. The latch 230 includes a handle 232 having a post 234 that is connected to a bar 236, such as by press fit pin 238, or alternatively by adhesive, threaded engagement or suitable alternative fastening means. The post 234 is received by an aperture 240 in a vertical rail 242 and accordingly the post 234 serves as a pivot for the latch 230. The vertical rail 242 has staggered inner and outer vertical edges 244, 246 that correspond to respective vertical edges on column 16, which together help to conceal the bar 236 and block viewing directly into the cavity 6 from outside of the popcorn machine 2.

In this example, the handle 232 of the latch 230 is accessible only from within the cavity 6 of the housing 4. Also, gravity is permitted to hold the bar 236 of the latch 230 in a horizontal, locked position, which may be seen in FIG. 7, where the bar 236 extends form the vertical rail 242 to engage a channel in column 16. With this example configuration, an operator may gain access through the rear of the popcorn machine 2. The access may be gained by first opening one or both of the hinged side panels 20, 22 and then by reaching through the cavity 6 to move the latch 230 by grasping and rotating the handle 232, thereby moving the bar 236 to a vertical, unlocked position. This unlocked position may be seen in FIG. 8, which also shows the side panel 26. further being pivoted to an open position. Such access may be beneficial for serving popped corn from another side of the machine and/or to better facilitate cleaning or maintenance of the machine.

It will be appreciated that the side panel 26 may be connected to or removed from the housing 4 when the side panel 26 is in an open position. For instance, to install the side panel 26, the side panel 26 is lifted into a position where the bores of the collars 216 on the vertical rail 220 of the side panel 26 are vertically above and aligned with the pins 214 of the collars 216 that are connected with the column 18. The side panel 26 is then lowered until the hinges 212 have been assembled. The bar 236 then may be pivoted upward to an unlocked position and the side panel 26 may be pivoted to a closed position, wherein the latch 230 may pivot to a closed position. To remove the side panel 26, the process essentially is reversed. Thus, when the side panel 26 has been pivoted to an open position, the side panel 26 then may be lifted to slide the bores in the collars 218 vertically upward and off of the pins 214 of the collars 216. In this manner, the side panel 26 may be at least temporarily removed to lessen any obstruction to an operator's access to the cavity 6, or for cleaning within the cavity or of the side panel 26. Removal of the side panel 26 also may be handy when seeking to service some other aspect of the popcorn machine 2 or in the event of the need to replace the side panel 26 due to damage to the transparent portion or some other component of the side panel.

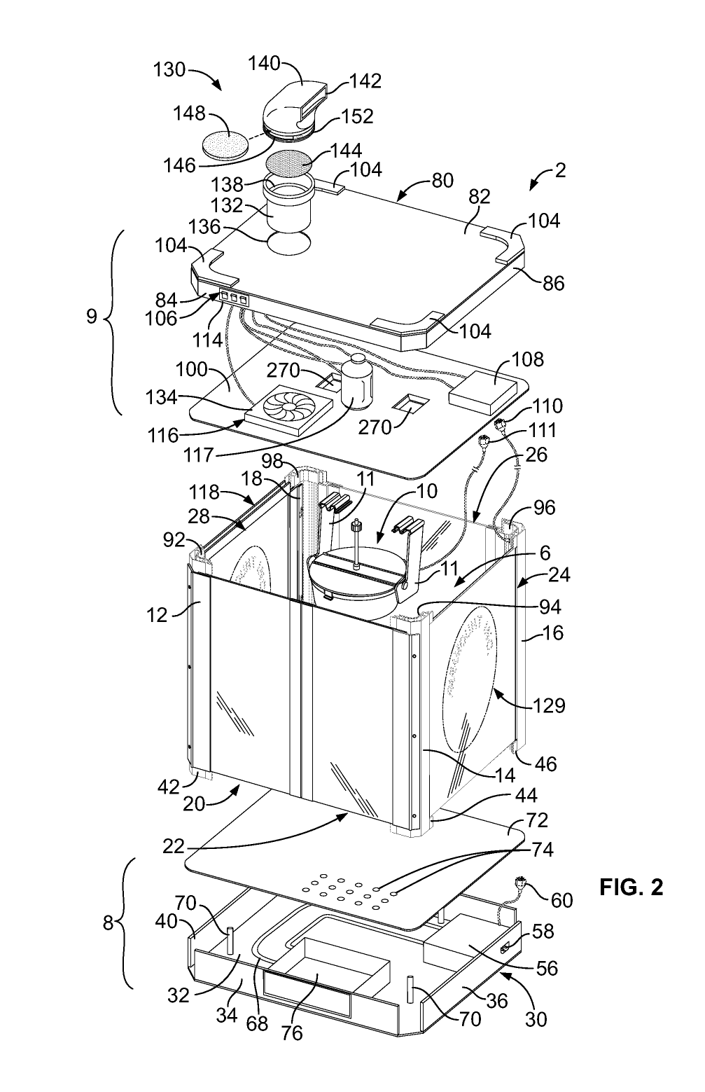

In the example shown, while the opposed side panels 24 and 28 could have utilized structures similar to those used for pivotal connection of side panels 20, 22, 26, the side panels 24, 28 instead are each connected to the housing 4 in a non-pivoting manner that may be seen at least in part in FIGS. 2, 4, 5 and 13-15, and will be described as to side panel 28. For instance, side panel 28 has a transparent portion that is connected to vertical rails 250, 252, in a manner similar to that already described above with respect to the other side panels. In this example, vertical rails 250, 252 have vertically spaced keyhole slots 254 having a raised elongated slot portion 256. The keyhole slots 254 are configured to receive posts 258 extending inward from the columns 12, 14, 16, 18. The posts 258 are located on a central portion of the column having a different cross-section than near the column top or bottom ends where the column slidably engages the upper and lower corner couplings, as seen in FIG. 5. The posts 258 also include heads 260 that are configured to be received through the circular portions of the keyhole slots 254 and then to provide a tensioning bias as the side panel 28 is moved downward by gravity and the heads 260 move along the elongated slot portions 256. In this manner, the side panels 24, 28 may be snuggly connected to the columns 12, 14, 16, 18. Depending on the actual configurations involved, side panels of this type may be arranged for assembly to the columns only prior to connection of the upper unit 9 to the columns, which would leave the such side panels locked in place once the upper unit 9 is connected to the columns, or such side panels could be arranged to be removably connected to the columns after the upper unit 9 has been connected to the columns. It will be appreciated that, given that the preferred material for the transparent portion of the side panels is glass, it is beneficial that the side panels include one or more vertical rails, which can help stiffen the transparent portions and lessen the incidence of breakage.

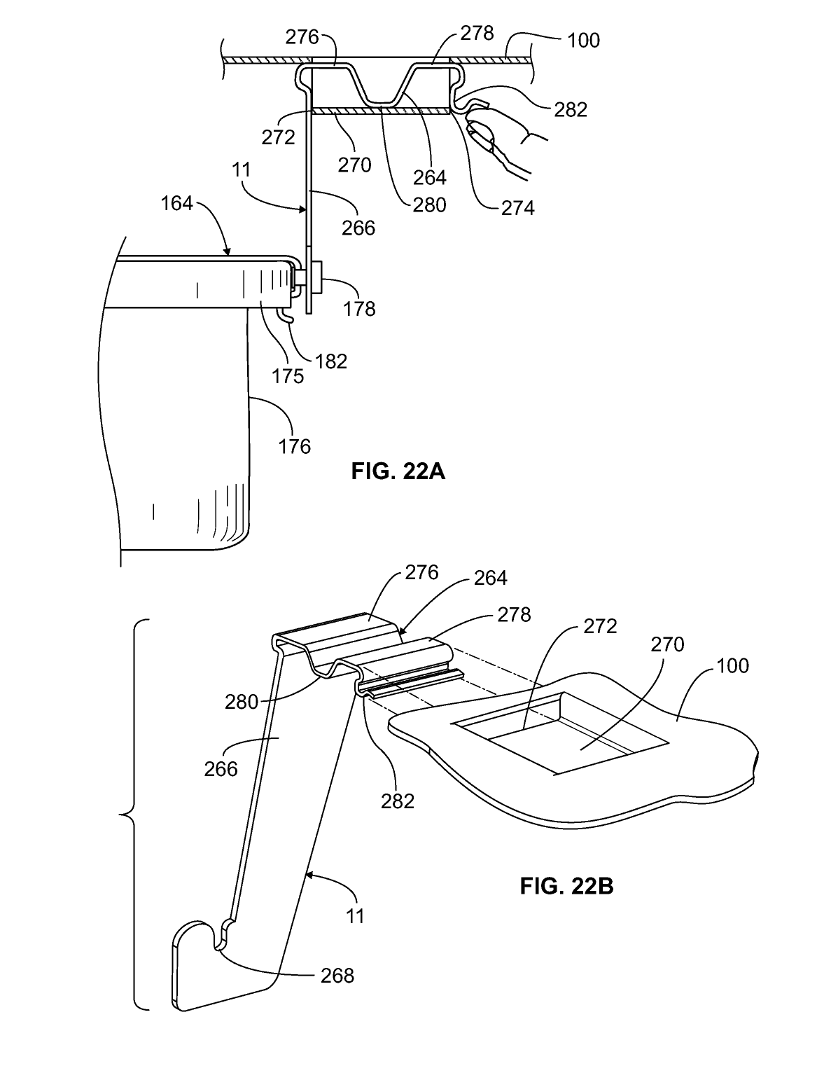

The kettle supports 11 were briefly mentioned above, but these components also include advantageous improvements over the prior art. For instance, prior art kettle supports generally are formed from stamped stainless steel sheet metal and are fixedly mounted to the ceiling of a cavity of a popcorn machine, such as by being bolted to a ceiling panel. Such prior art kettle supports extend rigidly downward into the cavity where they present hazardous obstacles to an operator who wishes to try to clean the kettle supports and the other surfaces within the cavity. As shown in FIGS. 2, 22A and 22B, the kettle supports 11 of the first embodiment of the present disclosure and other components of the popcorn machine 2 are configured to make the kettle supports 11 quickly and conveniently removable. This enhances the safety of the operator and the operator's access to clean the kettle supports 11 and the other surfaces within the cavity 6. Each kettle support 11 has a base portion 264 that removably connects to the ceiling panel 100 and an elongated portion 266 that extends downward from the base portion 264. The elongated portion 266 of the kettle support 11 includes an upward opening notch 268 that receives one of the posts 178 that extends outward from the central mounting panel 166 of the kettle assembly 10.

The ceiling panel 100 includes two coupling portions 270 in the form of stamped channels that provide openings in the ceiling panel 100. Each of the channels 270 includes a first edge 272 and an opposed second edge 274 and slidably receives a base portion 264 of one of the kettle supports 11. Each base portion 264 includes a series of bends that include two foot portions 276, 278 and a head portion 280 that cause the base portion 264 to have an offset depth that is sufficient to fill the channel 270. The first foot 276 is connected by a bend to the elongated portion 266, with the elongated portion 266 providing an insertion stop against the first edge 272. The second foot 278 is connected to a biasing portion 282, such as a biasing locking flange that includes draft angles to permit insertion of the base portion 264 and to lock the flange 282 against the second edge 274 when fully inserted in the channel 270. The end of the locking flange 282 may be pressed toward the ceiling panel 100 for quick tool-free removal of the kettle support 11 when it is desired to remove the obstruction and provide improved access to the cavity 6 of the housing 4.

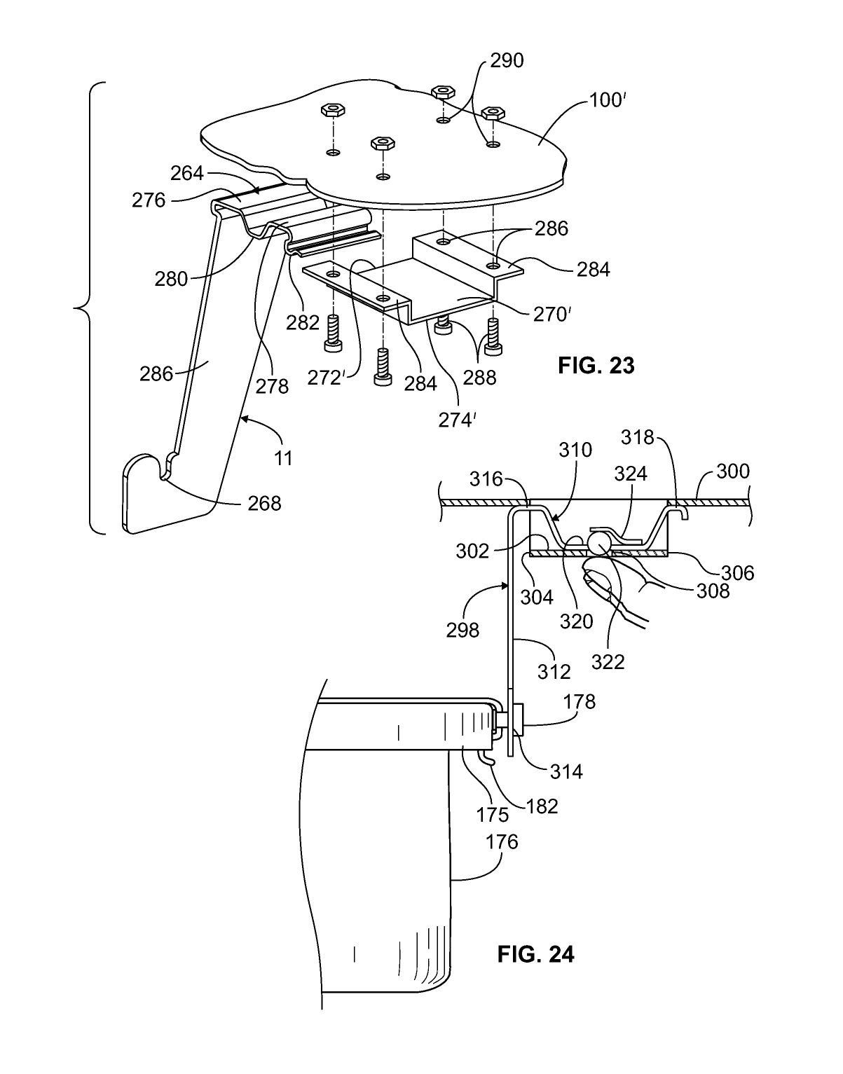

An alternative for connecting the removable kettle supports 11 to a ceiling of an upper unit is shown in FIG. 23. FIG. 23 shows a separate channel 270′ constructed of stamped sheet metal for connection to an alternative ceiling panel 100′. The channel 270′ has a first edge 272′ and second edge 274′. Rather than being integrally formed with the ceiling panel, the channel 270′ includes mounting flanges 284 having apertures 286 that receive nut and bolt fasteners 288 for connection to the ceiling panel 100′ having apertures 290. This presents a further example of a suitable means of connection for a conveniently removable kettle support.

Another example of a quickly removable kettle support is shown in FIG. 24. A kettle support 298 is shown removably connected to an alternative ceiling panel 300, using a ball and detent connection. For each kettle support 298, the ceiling panel 300 includes a coupling portion 302 in the form of a stamped channel that includes a first edge 304 and a second edge 306, as well as an aperture 308 that serves as a detent. It will be appreciated that the detent alternatively could be formed by an impression, or notch formed in the channel of the coupling portion. The kettle support 298 includes a base portion 310 and an elongated portion 312 that extends downward from the base portion 310. The elongated portion 312 of the kettle support 298 includes an upward opening notch 314 that receives one of the posts 178 that extends outward from the central mounting panel 166 of the kettle assembly 10.

Each base portion 310 includes a series of bends that include two foot portions 316, 318 and a head portion 320 that cause the base portion 310 to have an offset depth that is sufficient to fill the channel 302. The first foot portion 316 is connected by a bend to the elongated portion 312, but the elongated portion 312 need not provide an insertion stop against the first edge 304 because the head portion 320 includes a ball 322 on a biasing portion 324, such as a biasing arm, with the ball 322 having a diameter that is larger than the diameter of the detent, aperture 308 in the channel 302, thereby providing ball and detent connection having a locking stop when the ball 322 engages the aperture 308. Upon slidable receipt of the base portion 310 within the channel 302, the ball 322 will cause the biasing arm 324 to deflect while the ball 322 rides over the surface of the channel 302 until the ball 322 engages the aperture 308. When engaged, the ball 322 removably locks the kettle support 298 in an installed position ready for the notch 314 to receive a post 178 of the kettle assembly 10 to hang the kettle assembly 10 within the cavity 6 in the housing 4. To quickly and conveniently remove the kettle support 298, the ball 322 is pressed upward slightly to permit the ball 322 to exit the detent, aperture 308, and the base portion 310 to be released and removed from the channel 302.

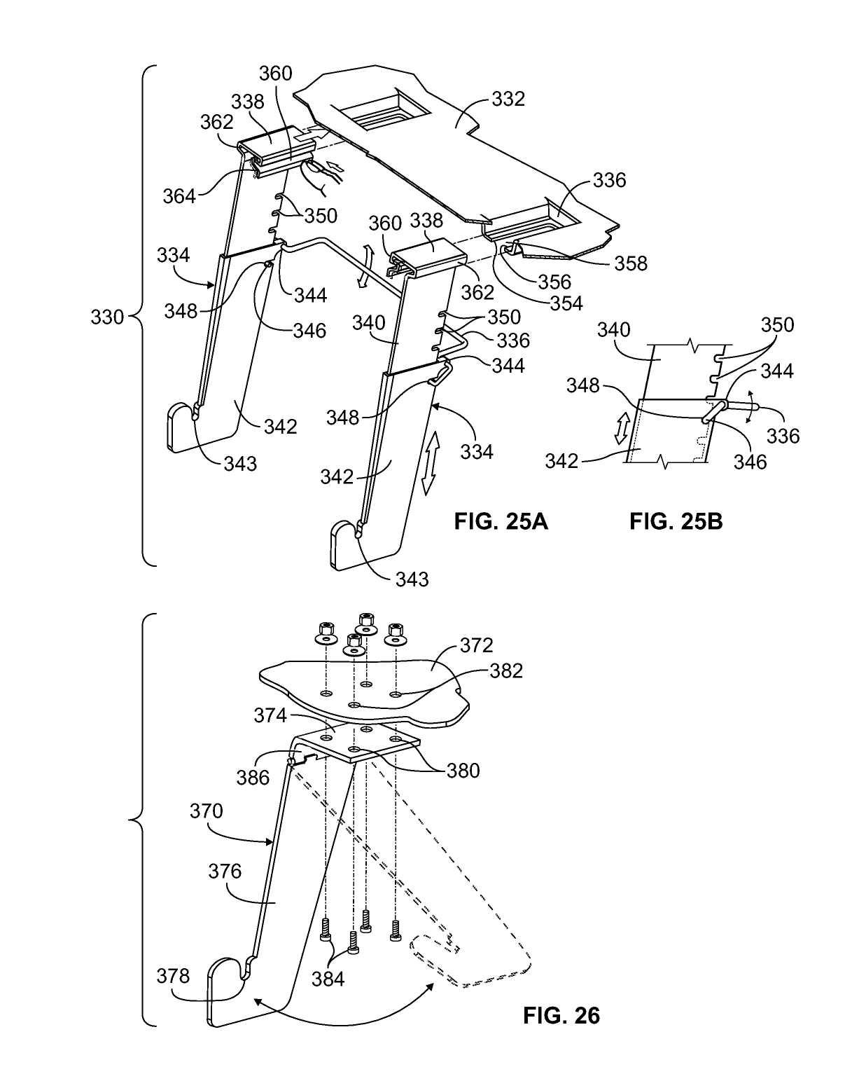

In FIGS. 25A and 25B, an example further kettle support assembly 330 and ceiling panel 332 are illustrated. These example components not only permit quick, tool-free removal of the kettle support assembly 330, but also permit an installed kettle support assembly 330 to be lengthened, so as to lower a kettle assembly to provide more space above the kettle assembly for more convenient refilling of the kettle assembly between successive corn popping batches. In this example, the kettle support assembly 330 includes a pair of removable kettle supports 334 that are linked by a pivotally mounted handle 336. The kettle supports 334 include base portions 338 and elongated portions 340 that extend from the base portions 338. Second elongated portions 342 slidably receive the respective elongated portions 340 at their upper ends and have a notch 343 at their lower end to receive a post 178 of a kettle assembly. The handle 336 is shown as being of bent wire construction and includes portions that are pivotally received in bores 344 at the rear of the elongated portions 342. The handle 336 includes stop ends 346 that are received in slots 348 in the elongated portions 342, as well as in any one of the series of slots 350 in the rear of the elongated portions 340 to selectively adjust the length of the kettle supports 334. Thus, by pivoting the handle 336, an operator may unlock the elongated portions 342 for slidably lowering and raising the kettle supports 334.

In this example, the ceiling panel 332 includes two coupling portions 352 in the form of stamped channels that provide openings in the ceiling panel 332 to receive the base portions 338 of the kettle supports 334. Each of the channels 352 includes a first edge 354 and an opposed second edge 356 having an opening 358 therebetween that slidably receives the base portion 338. Each base portion 338 includes a series of bends that form two foot portions 360, 362 and a biasing portion 364, such as a biasing flange. The foot portions 360, 362 provide an offset depth that is sufficient to fill the channel 352. The channel 352 includes a rear wall 366 that stops insertion of the base portion 338. The biased flange 364 may be depressed to permit easy sliding of the base portion 338 into and out of the opening 358 in the channel 352, and released once the base portion 338 is inserted fully into the channel 352 to provide snug retention of the kettle support 334.

FIG. 26 illustrates a further alternative kettle support 370 that would be used in pairs to support a kettle assembly in a popcorn machine and that provides an advantage of being able to be moved out of the way when an operator chooses to reach into the cavity of a housing of a popcorn machine to clean surfaces within the cavity or to otherwise service the machine. The kettle support 370 is shown with an alternative ceiling panel 372. The kettle support 370 includes a base portion 374 and an elongated portion 376 that extends downward from the base portion 374 and includes a notch 378 that receives a post of a kettle assembly. The base portion 374 includes apertures 380 and the ceiling panel 372 includes a coupling portion 382 in the form of corresponding apertures. The apertures 380, 382 receive fasteners 384, which may be of a configuration to provide fixed or removable connection of the base portion 374 to the ceiling panel 372. Thus, the fasteners may include nuts and bolts, rivets or other suitable fasteners. In the alternative kettle support 370, the elongated portion 376 is pivotally connected to the base portion 374, such as via a hinge that may have components formed integrally with the base and elongated portions, or may be of a separate hinge construction having respective components connected to the base and elongated portions of the kettle support. In this example, the base portion 374 includes a setoff portion 386 that permits the elongated portion 376 to be pivoted from a use or extended position substantially perpendicular to the ceiling panel 372 to a retracted position close to and substantially coplanar with the ceiling panel 372. Accordingly, the kettle support 370 may be effectively moved out of the way by an operator who chooses to remove the kettle assembly from the cavity and to clean or provide other servicing within the cavity of the housing of a popcorn machine.

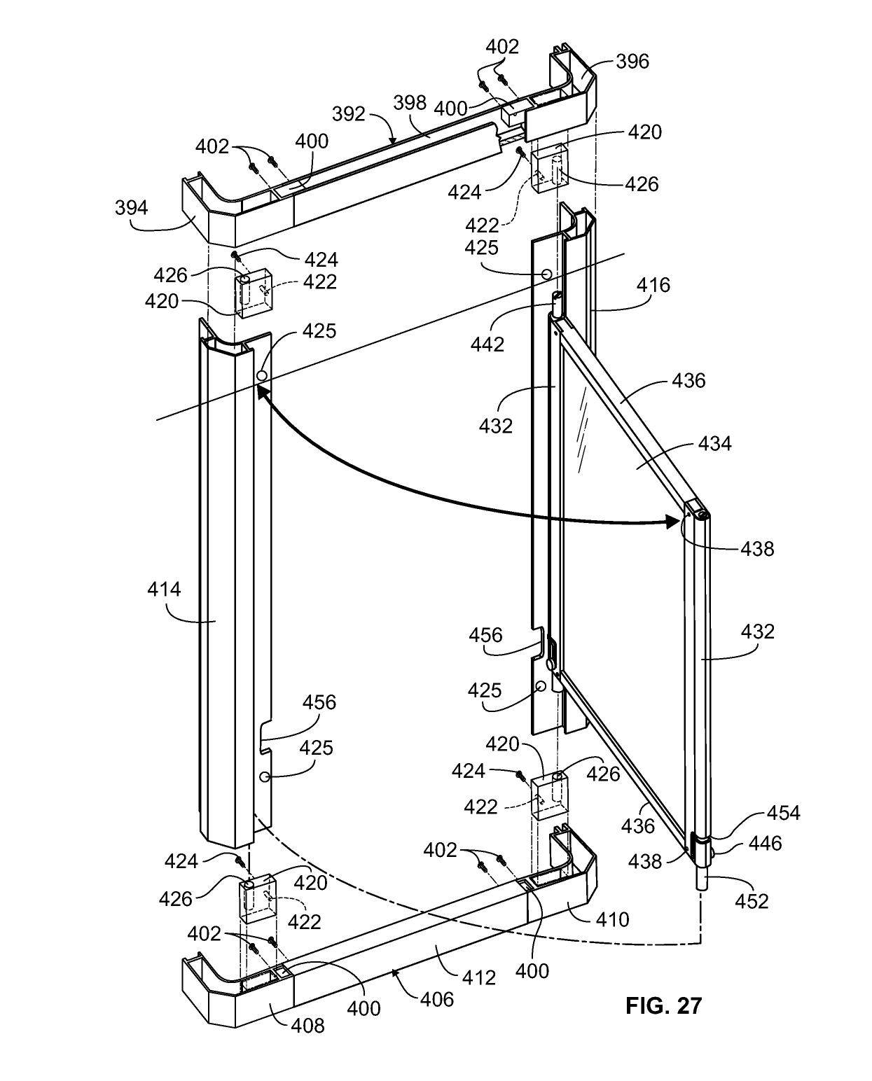

FIGS. 27-32 provide an alternative example configuration for components of a popcorn machine with respect to the construction of the columns and side panels. The alternative example provides an advantageous universal side panel connection system that permits side panels to be configured to be either non-movable or pivotal, depending on the position of pins at the top of the side panels. FIG. 27 illustrates components that form a portion of one side of a housing of a popcorn machine, such as a right side of a machine. An upper assembly 392 includes upper couplings 394, 396 and a bridging element 398 extending therebetween. The upper couplings 394, 396 would be connected to or formed as a part of a body, similar to the body 80 of the upper unit 9 of the first example popcorn machine 2. The bridging element 398 is connected at its ends to the upper couplings 394, 396 by fittings 400 that are held in place by fasteners 402, such as screws or by other suitable means of connection. Similarly, a lower assembly 406 includes lower couplings 408, 410 and a bridging element 412 extending therebetween. The lower couplings 408, 410 would be connected to or formed as a part of a body, similar to the body 30 of the base unit 8 of the first example popcorn machine 2. The bridging element 412 is connected at its ends to the lower couplings 408, 410 by fittings 400 that are held in place by fasteners 402, such as screws or by other suitable means of connection. It will be appreciated that either or both of the upper and lower bridging elements may additionally be configured as lighting fixtures, somewhat similar to those shown in FIGS. 3 and 5, with a modification to help direct the light to at least partially exposed the edges of a transparent portion of the side panel when in a closed position.

Example columns 414, 416 are configured to be slidably received in the upper couplings 394, 396 and in the lower couplings 408, 410. Connections to the columns may be by quick release spring locks, such as were shown in the first example embodiment, or may include other fasteners that are intended to be removable or fixed, and are not shown for ease of viewing the other components. Coupling blocks 420 of this example are to be fixedly connected to the upper couplings 394, 396 and lower couplings 408, 410, by welding, adhesives or use of mechanical fasteners, and are intended to be located along both sides of the upper and lower couplings, as shown for example with respect to the lower coupling 408, in the lower left corner. Also, the coupling blocks alternatively may be connected by similar means of connection to one or both sides of the upper and lower ends of the columns 414, 416. In this example, the coupling blocks 420 also include a threaded bore 422 that receives a fastener 424, such as a screw. Thus, each upper and lower corner may be connected by installation of a single screw that passes through and connects an upper or lower coupling to a column, at an aperture 425, as well as to a coupling block 420. The coupling blocks 420 also include bores 426, which when in the upper couplings 394, 396 face downward and when in the lower couplings 408. 410 face upward.

A side panel 430 is shown in FIG. 27 with vertical rails 432 connected to each side edge of a central portion 434, which may be transparent. The horizontal rails 436 also may be connected to the top and bottom edges of the central portion 434. The vertical and horizontal rails 432, 436 may be connected to the central portion and/or to each other by a fastener 438, or by other suitable means of connection, such as adhesives or the like. It will be appreciated that any of the vertical or horizontal rails 432, 436 could alternatively include a lighting fixture that places a light source at an edge of the central portion 434. Each vertical rail 432 includes a threaded bore 440 at an upper end that receives a threaded pin 442, while each lower end includes a latch 444. The latch 444 includes a handle 446 having a threaded post 448 that engages a threaded bore 450 in a slidable pin 452. The slidable pin 452 and handle 446 are movable within a slotted opening 454 in the vertical rail 432, with the slotted opening 454 permitting the handle 446 to be moved to a location on either side of the side panel 430, so as to be available for grasping only from within the cavity of the machine or from outside of the machine, and with gravity biasing the latch 444 to a closed position. To accommodate positioning of the handle 446 within the cavity, a notch 456 is provided in each column 414, 416.

This structure including threaded and slidable pin structures for side panels permits a variety of configurations that are completely customizable by the operator. For instance, if an operator wishes to configure the side panel 430 to prohibit opening from outside of the machine, the threaded pins 442 at the upper end of the vertical rails 432 may be rotated so as to extend upward to engage the bores 426 of the coupling blocks 420 in the upper couplings 394, 396. The slidable pins 452 at lower end of the vertical rails 432 are moved to extend downward into the bores 426 of the coupling blocks 420 and to have the handles 446 on the inside of the cavity, which is consistent with pinning the side panel 430 in a manner that will not permit it to be opened from outside of the machine. Note, however, for convenience, even in this configuration, if both handles 446 of the latches 444 are moved upward, the bottom of the side panel 430 could be move outward to permit the side panel 430 to then be moved downward, removing the threaded pins 442 at the upper end of the vertical rails 432 from the bores 426 in the coupling blocks 420 in the upper couplings 394, 396. Such full removal of the side panel may facilitate cleaning or servicing of the cavity within the housing of the machine or convenient replacement of the side panel or reconfiguring with respect to its ability to be pivoted to an open position.

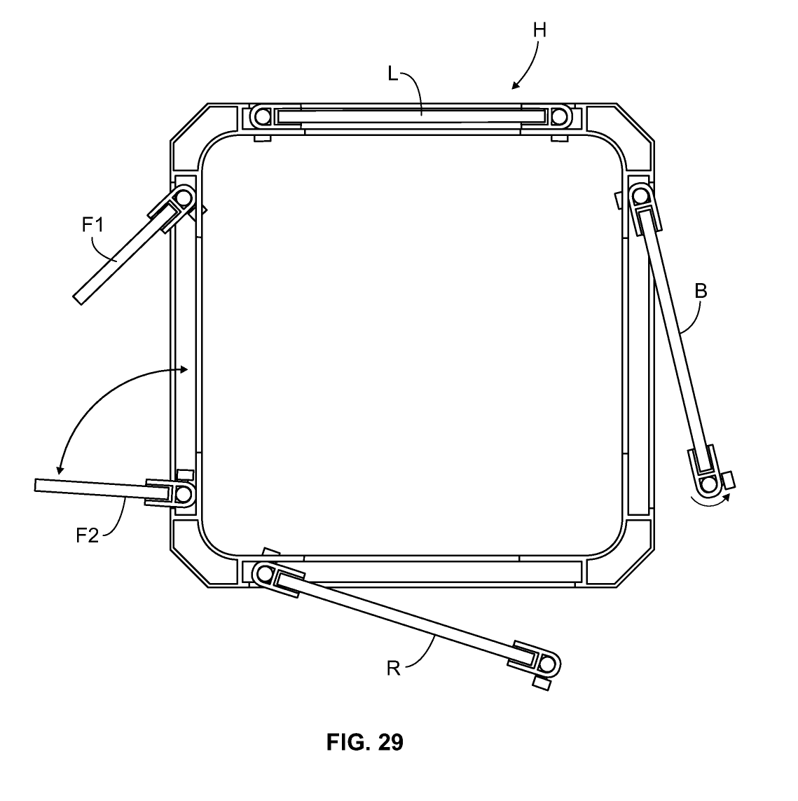

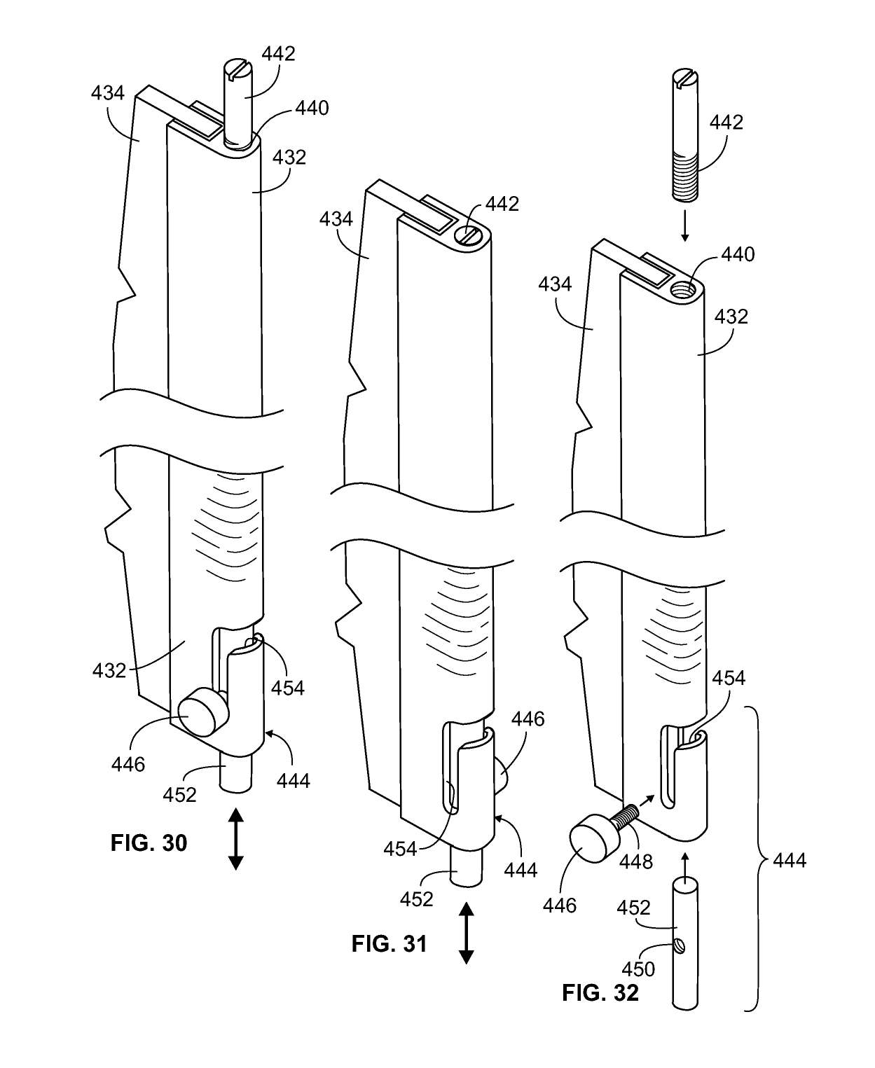

In contrast, if the operator knows that it is desirable to be able to pivotally open the side panel 430, then the operator can configure the side panel to be pivotally connected and to have the handle 446 of a latch 444 that is accessible from inside the cavity or from outside of the machine. This is possible by simply extending upward the threaded pin 442 that would be on the hinged side of the side panel 430, such as shown in FIG. 30, while rotating the threaded pin 442 to be completely recessed within the vertical rail 432 on the opposed side, as shown in FIG. 31, where the latch 444 would be used to unlatch and pivot the side panel to an open position, when desired. In a manner similar to that described above, if both of the latches 444 are move upward, the side panel may be fully removed.

Simplified views of these configurations are shown in FIG. 29, without the upper or base units or their respective upper couplings 394, 396 and lower couplings 408, 410 that would include the coupling blocks 420. For instance, a side panel R on the right side of the housing H is hinged at its left side and has a latch with a handle that is operable from outside of the housing H. A side panel B on the back side of the housing H is hinged on its right side and a latch is shown having been grasped from inside of the housing H and moved to be able to open the side panel B and then being moved within the slotted opening of the latch to be available to grasp from the outside of the housing H. On the left side of the housing H, a side panel L is shown having the threaded pins at the top of the vertical rails extended, so as to prevent opening of the side panel L. Finally, in the front of the housing H, side panels F1 and F2 are shown with the pins extended from the vertical rails at the outer sides of the side panels F1, F2 to provide hinged panels, while not having full vertical rails along the opposed side edges because the side panels F1, F2 are to be used as the operator's primary doors for the housing H. One can appreciate that such selective ability to open the side panels of a machine presents great opportunities for an operator, and new potential uses and arrangements for a machine having such capabilities, all of which still permit the side panels to be fully removed, as above described.

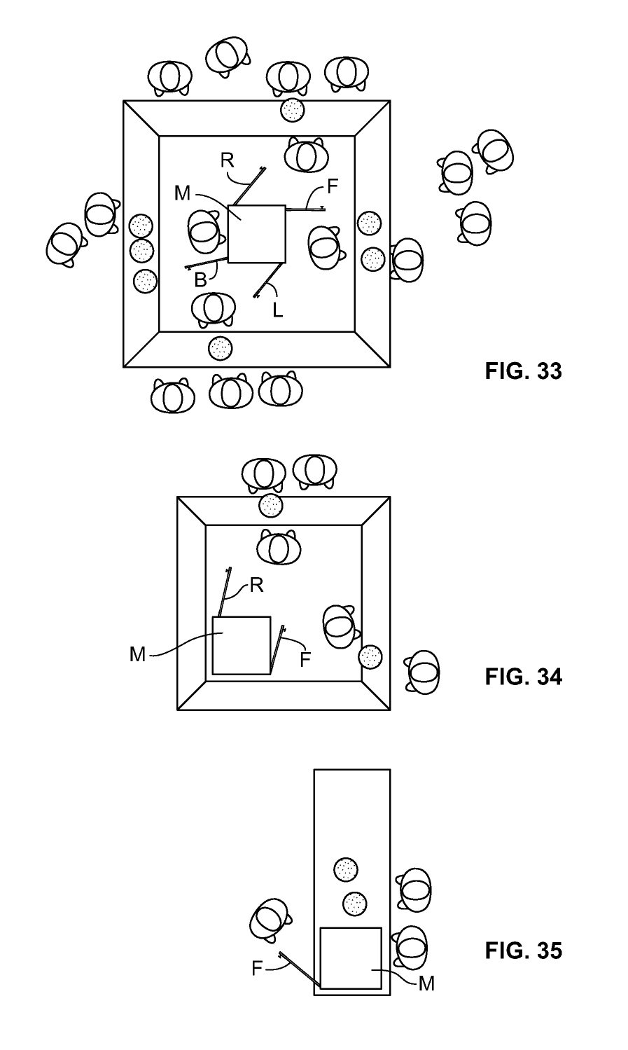

Three potential arrangements that utilize the customizable side panel opening configurations are shown, for example, in FIGS. 33-35. For instance, in FIG. 33, a popcorn machine M is shown having a side panel F, R, B, L that can be pivoted to an open position on each of the four sides of the machine M. Such a configuration may be usable in a situation where a machine is located at a busy venue, such as a fair ground, where operators could be stationed on all four sides of the machine while it is located within a counter arrangement that has patrons approaching from all four sides. FIG. 34 shows a popcorn machine M located in the rear corner of a counter space with two operators and the ability to open the side panels F, R on the two sides of the machine M that may be approached by operators. FIG. 35 shows a popcorn machine M located on a common retail counter or bar top, and being configured to have only one side panel F that may be pivoted to an open position, on the side approachable by the operator. In reality, with this construction, there are many ways in which the side panels could be configured to prohibit or permit access from outside of the machine, while allowing the operator to choose to position the handles 446 of the latches 444 to be grasped from inside or outside of the cavity of the machine, and retaining the ability to remove any of the side panels for cleaning, servicing or replacement of components.

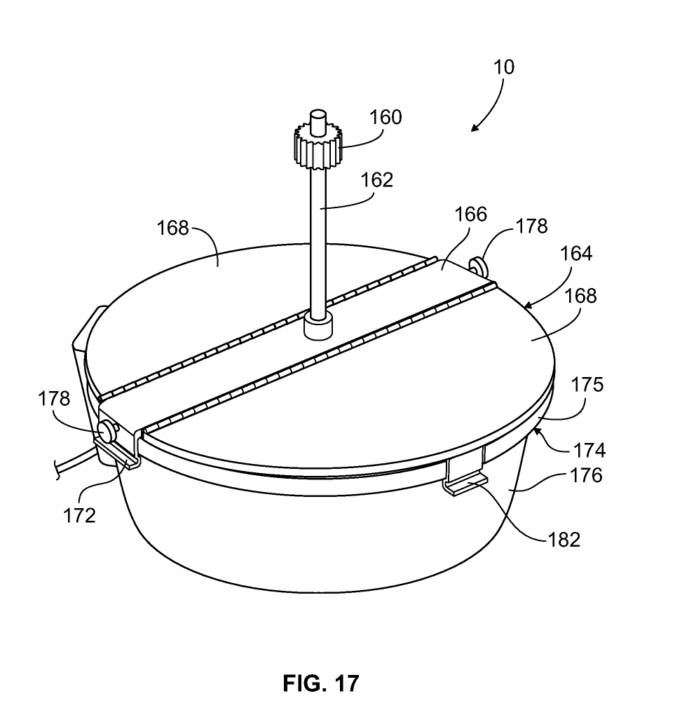

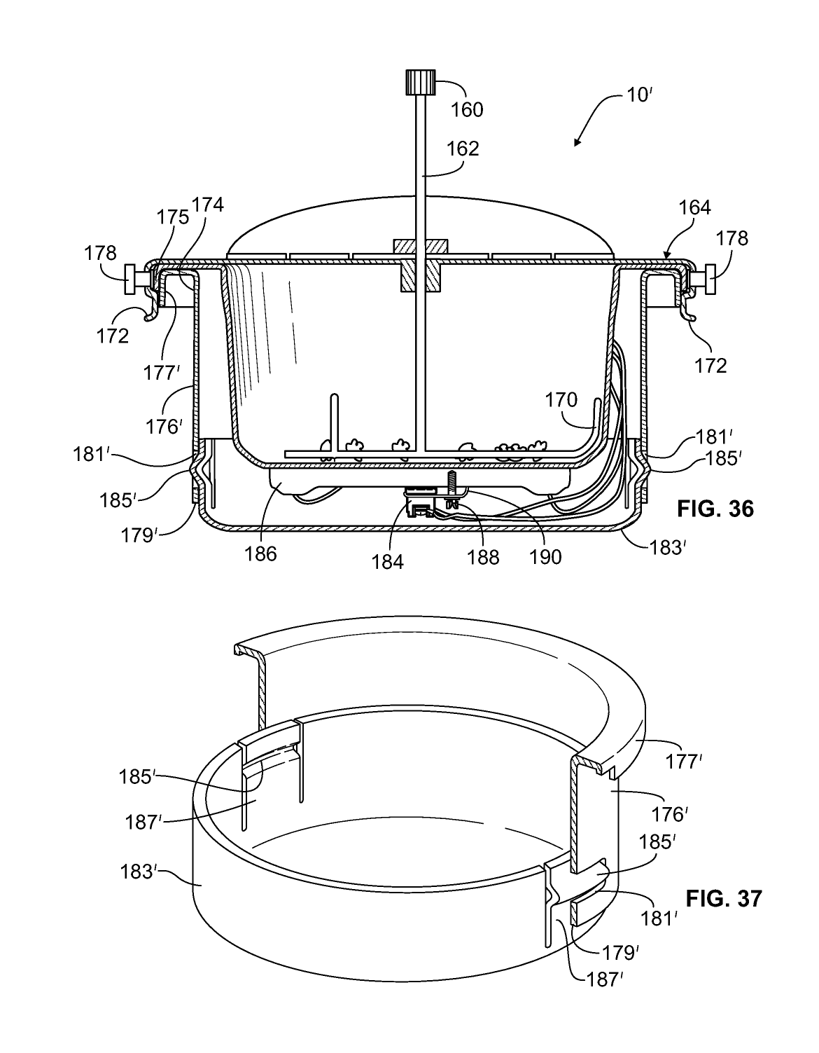

Turning to FIGS. 36 and 37, an alternative kettle assembly 10′ is shown as including many of the same components as the previously described kettle assembly 10 of FIGS. 17-19, and therefore, similar numbering will be used and the description of like components will not be repeated. However, the kettle assembly 10′ differs in the construction of its outer kettle bowl 176′. The outer kettle bowl 176′ includes a rim 177′ but does not include an integrally formed bottom. Instead, the outer kettle bowl 176′ has an open lower end 179′ and includes locking receptacles 181′ in the form of slotted apertures in the side wall of the outer kettle bowl 176′. The open lower end 179′ receives a bowl closure element 183′, configured to have a cup shape and to be slidably received within the open lower end 179′ of the outer kettle bowl 176′.

The bowl closure element 183′ includes protrusions 185′ in its sidewalls that are biased for receipt by the locking receptacles 181′. The protrusions 185′ are located on tabs 187′ cut in the sidewall of the outer kettle bowl 176′, which provide biasing by their tendency to resist bending. Accordingly, as the bowl closure element 183′ is aligned with the open lower end 179′ of the outer kettle bowl 176′ and slidably moved into engagement therewith, draft angles on the protrusions 185′ permit the protrusions 185′ to deflect and slide along the interior surface of the outer kettle bowl 176′ until the protrusions 185′ reach and enter the locking receptacles 181′. In the event that an operator needs to access the space between the inner kettle bowl 174 and the outer kettle bowl 176′, the operator may reverse the assembly process by depressing or otherwise forcing the protrusions 185′ inward until they release from the locking receptacles 181′ and the bowl closure element 183′ is permitted to slidably move apart from and disengage the outer kettle bowl 176′. In this manner, an operator may quickly and conveniently access the electrical components in the kettle assembly 10′ if they are in need of inspection, servicing or replacement. It will be appreciated that other configurations for removable bowl closure elements, such as a pivotal or sliding door on the bottom of the outer kettle bowl 176′, may be utilized to gain access to the electrical components that are connected to the underside of the inner kettle bowl 174.

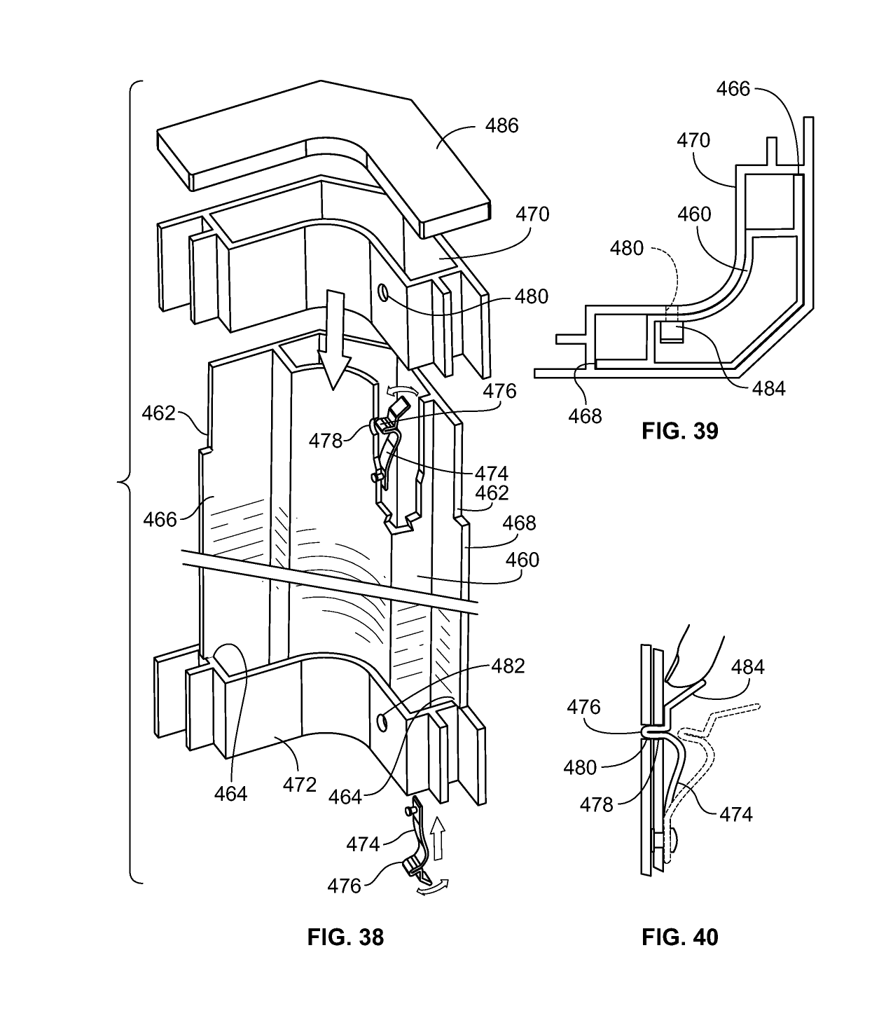

An alternative embodiment for column and upper and lower coupling portions is illustrated in FIGS. 38-40. This embodiment utilizes a sleeved fit of the upper and lower couplings to respective portions of the column, and a self-locking means for maintaining connection between respective components. A column 460 is shown having a structure along its outer sidewalls that includes recesses 462, 464, respectively, that are cut from the side edges 466, 468 of the column 460 and which are located at near the upper and lower ends of the column. The recesses 462, 464 provide stops at the transitions to the wider outer edges 466, 468, which serve as positive locating features when the upper and lower ends of the column 460 are slidably engaged with and received within an upper coupling 470 and a respective lower coupling 472.

In this example embodiment, to removably connect the upper and lower couplings to the column in a tool-free manner, the column includes spring locks 474 having posts 476 that would be directed toward the cavity of the machine. The spring locks 474 may be fastened to the column 460, such as by rivets or other means of connection. The spring locks 474 also are biased to cause the posts 476 to pass through apertures 478 in the column 460, as well as into respective apertures 480, 482 in the upper and lower couplings 470, 472 when the upper and lower couplings 470, 472 reach the stops provided by the recesses 462, 464. As noted with respect to the prior embodiment, the fit of the spring locks could be configured to cause them to audibly snap into place when received within the apertures 480, 482. Also, the posts 476 would be visible within the apertures 480, 482 and could be forced rearward, if desired to disengage the spring locks 474 for removal of an upper or base unit that includes the upper or lower couplings.

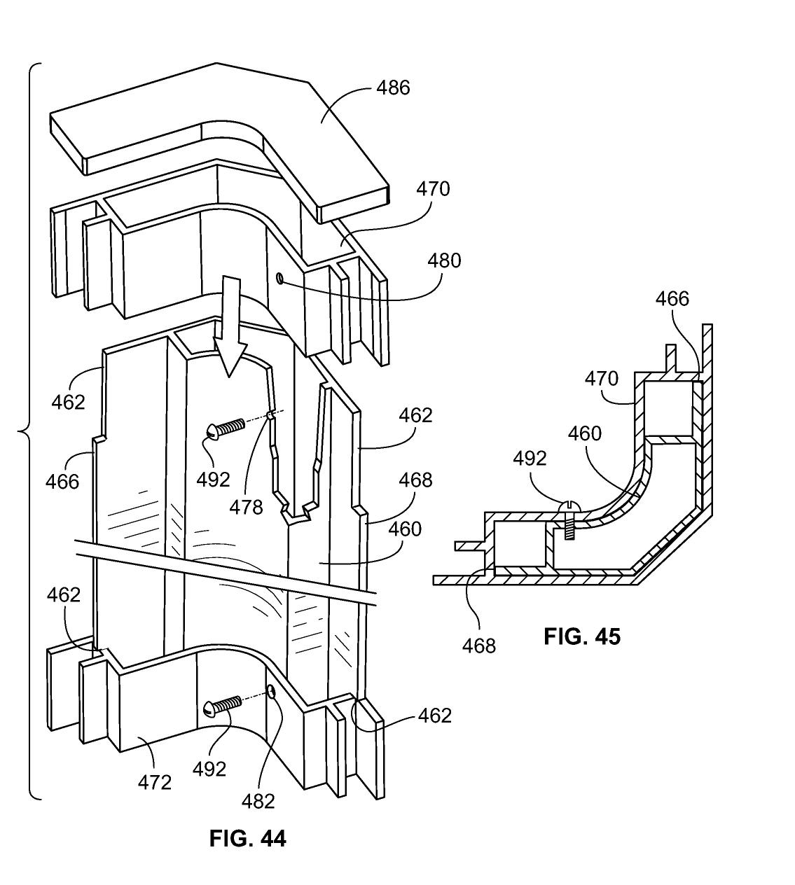

This example also provides an alternative way to release the connection established by the spring locks 474. As shown in FIG. 40, to disengage a spring lock 474, such as at the connection of an upper coupling 470 to an upper end of the column 460, an operator may press a release tab 484 that acts as a lever and withdraws the post 476 from the aperture 480, thereafter permitting slidable removal of the upper coupling 470 from the column 460. A cap 486 may be used to close the top of the upper coupling 470, which may be above or could be incorporated into an upper unit cover on the machine. It will be appreciated that the spring locks could be constructed in a different configuration and that one or more spring locks may be used at the connection of each component to another component. Also, alternative means of connecting the upper and lower couplings to the column may be employed, depending on whether or not it is desired to have the connections be releasable. For example, if the construction of the popcorn machine will be completed and there will be no need or desire to disassemble the upper and/or lower couplings from a column, then fasteners that are intended for more fixed construction, such as rivets, may be used. However, use of fasteners, such as a screw, could be comparable for connection purposes while remaining removable with minimal use of tools, as discussed below with respect to an alternative example shown in FIGS. 44 and 45.

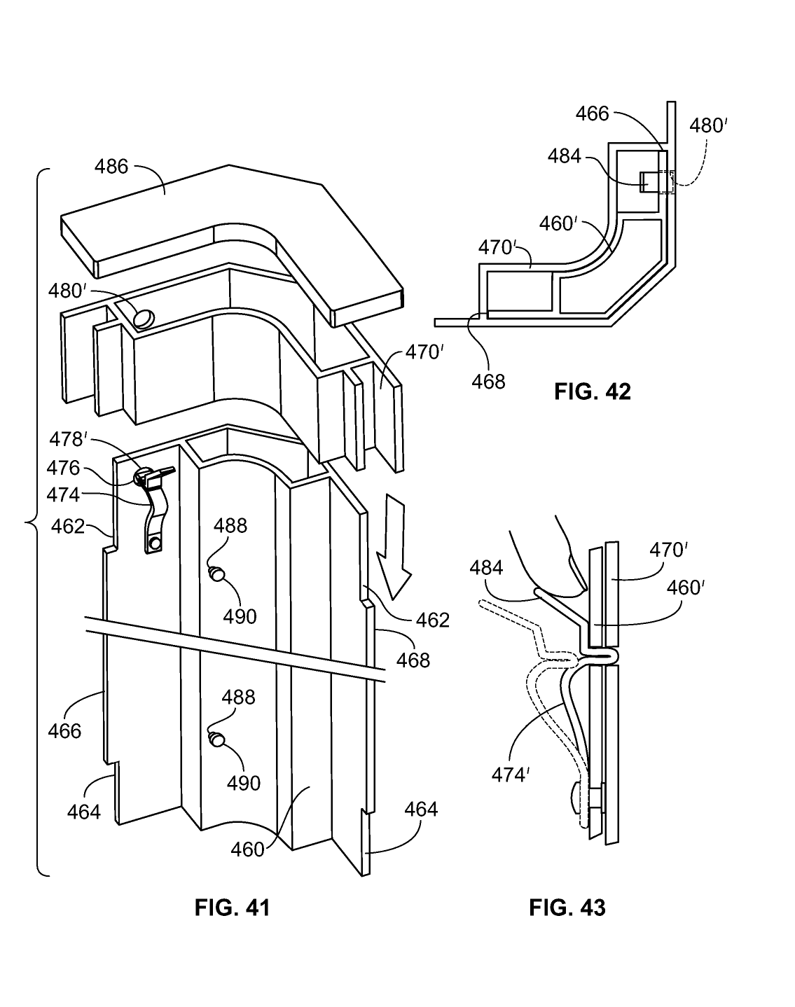

A further alternative embodiment for column and upper and lower coupling portions is illustrated in FIGS. 41-43. This embodiment is quite comparable to the immediately preceding example in FIGS. 38-39, and therefore, will rely on the description already provided, except with respect to the fact that the spring locks 474 are configured to face outward, which will result in the posts 476 of the spring locks 474 extending through, for example, an aperture 478′ in the column 460′ and through an aperture 480′ in an outer wall of the upper coupling 470′. Thus, the seating of the post 476 in the aperture 480′ will provide positive confirmation of a successful connection of the components and will permit an operator to access and depress the spring lock 474 from outside of the machine. The only other difference between this example and the one immediately preceding it is that the column 460′ includes posts 488 having heads 490 for connection of side panels that utilize keyhole slots, such as were described with respect to the first embodiment. The prior statements regarding alternative spring lock configurations and fasteners, whether intended to be removable or not, apply equally to this embodiment.

FIGS. 44 and 45 effectively show the example of FIGS. 38-40, but using a removable threaded fastener 492, instead of spring locks 474. Accordingly, the same description and reference numerals apply to this further example, other than with respect to using the single screw 492, for instance, when an upper coupling 470 reaches the stops formed by the recesses 462 and the apertures 478 and 480 are aligned. At such time, the threaded fastener 492 could be rotated to be driven inward, so as to form a connection that would resist inadvertent removal of an upper coupling 470 from a column 460.

It would be preferable for the aperture 478 in the column 460 to be threaded and the aperture 480 in the upper coupling 470 to be a bore slightly larger than the diameter of the threaded fastener 492, so as to apply a clamping load when the threaded fastener 492 is rotated to a tightened position, resulting in a snug connection of the components. However, the aperture 478 could be threaded and the aperture 480 could be presented as a bore slightly larger than the diameter of the threaded fastener 492, so as to permit the fastener to be conveniently retained in the upper coupling 470 while being completely removed from the aperture 478 in the column 460. This would allow an operator to leave the fasteners 492 connected to components when disassembling a machine, as opposed to having to collect and retain the fasteners elsewhere. Depending upon whether or not the configuration of the upper and lower couplings and column permit access to the inside of the column, alternative arrangements may include a nut affixed to an inner wall of the column to receive the threaded fastener. It will be appreciated that the overlapping sleeved fit, in conjunction with a single connector will provide a stable connection. Moreover, as was shown with respect to the spring locks of the prior two examples, the fasteners could be configured to be accessed and manipulated from inside the cavity of a popcorn machine or from along the outside of the machine.

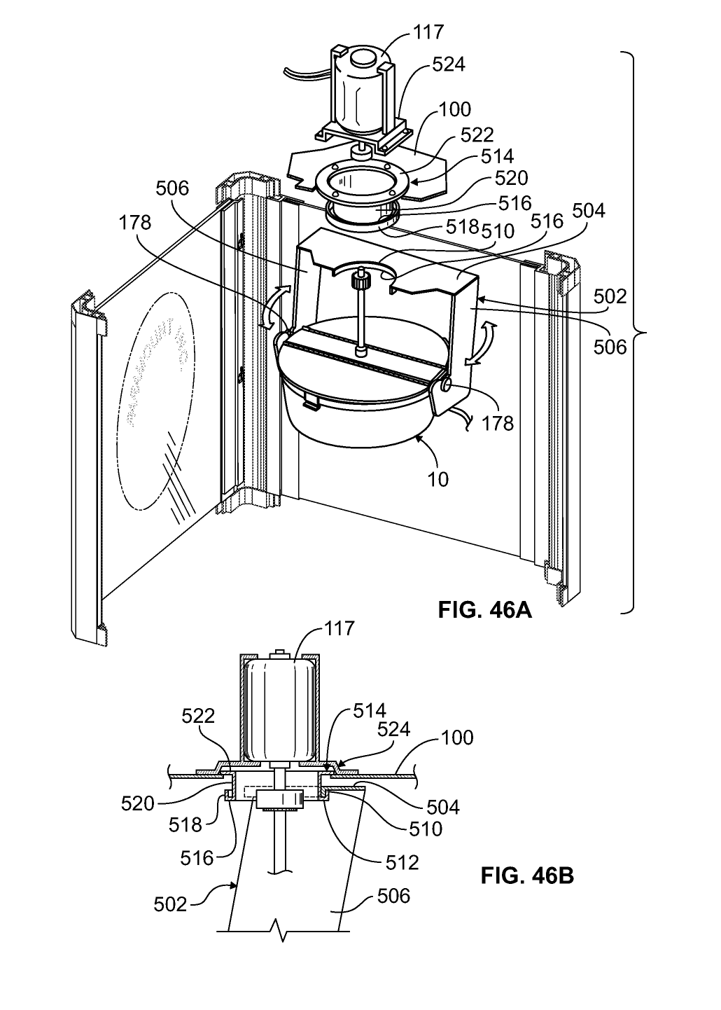

Turning to FIGS. 46A and 46B, a further example of an adjustable kettle support assembly is illustrated. Previously discussed with respect to FIGS. 25A and 25B is a height adjustable kettle support assembly 330 that provides the ability to lower a kettle assembly 10 for greater ease in filling or otherwise accessing the top of the kettle assembly. The kettle support assembly 500 shown in FIGS. 46A and 46B provides another approach using movable or adjustable kettle supports to permit an operator greater access from above a kettle assembly, such as when adding further oil and corn for successive popping sessions.

The kettle support assembly 500 includes a kettle support bracket 502 having a base portion 504 from which two elongated portions 506 extend downward and provide notches 508 to receive the posts 178 of a kettle assembly 10. The kettle support bracket 502 is generally U-shaped in that the base portion 504 spans approximately the width of a kettle assembly between the downward extending elongated portions 506. Centrally located on the base portion 504 is a circular-shaped collar 510 having a downward extending flange or rim 512. The downward extending rim 512 is removably received by a kettle support connector 514 having a corresponding circular-shaped collar 516. The collar 516 includes an upwardly extending flange or rim 518 that engages the rim 512 of the base portion 504. The kettle support connector 514 of this example includes a tubular body 520 having a radially extending flange 522 at its upper end. The flange 522 may be connected to the ceiling panel 100 of the upper unit 9, by use of removable fasteners, such as nuts and bolts, or by more permanent fastening means, such as by rivets, welding, adhesives or other suitable means of connection. The components are shown in the surrounding environment which includes the kettle assembly 10 and a motor 117 having a mounting fixture 524 for connection to the ceiling panel 100 in any of the ways noted with respect to connection of the flange 522. It will be appreciated that this construction would permit an operator to rotate the kettle support assembly 500 toward or away from the operator, so as to achieve a better angle of approach when trying to access the top of the kettle assembly 10 and to correctly position the kettle assembly 10 during popping.

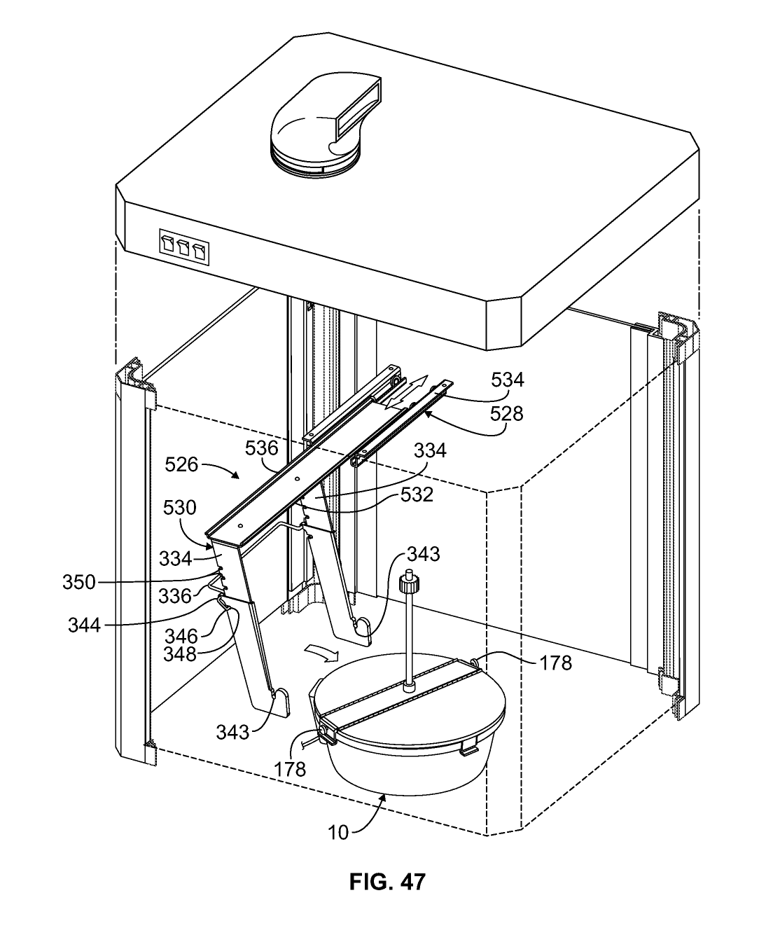

A further alternative embodiment for an improved kettle support assembly is illustrated in FIG. 47. The kettle support assembly 526 of FIG. 47 provides a slide system 528 that permits an operator to selectively move a kettle assembly 10 toward the operator for enhanced access to the top of the kettle assembly 10, such as when adding additional oil and corn to for popping, and then back into an appropriate position within the cavity for popping the corn. The kettle support assembly 526 includes a further optional enhancement by including the height adjustment structure from the kettle support assembly 330 shown in FIGS. 25A and 25B. In this example, a kettle support bracket 530 includes a base portion 532, in place of the base portions 338, and which spans between the two first elongated portions 340 that extend downward and are slidably received by second elongated portions 342 to support a kettle assembly 10 at notches 343. A handle 336, received in bores 344, stop ends 346, and slots 350 of the height adjustment mechanism shown in FIGS. 25A and 25B are used in the kettle support assembly 526 in the same manner and provide similar advantages as those previously described.

The slide system 528 includes at least two slide members, and in this example is shown with a first slide member 534 and a second slide member 536 that is slidable relative to the first slide member 534. The first slide member 534 is connected to the base portion 532. The connection of the first slide member 534 to the ceiling panel 100 and the connection of the second slide member 536 to the base portion 532 may be by mechanical fasteners, such removable nuts and bolts, or by more permanent means, such as by use of rivets, welding, adhesives or other suitable means of connection. Depending on the length of the power cord 111 of the kettle assembly 10, the configuration of the components of the slide system 528, such as the length of the slide members and whether the slide system uses two or three slide members, as well as the height at which the slide system is connected to the ceiling panel, the kettle assembly may be movable to a position where it remains within the cavity or passes through a side panel opening to be located entirely outside of the cavity. It will be appreciated that the kettle support assembly 526 provides significantly enhanced access to the top of a kettle assembly 10 and to the surfaces within the cavity.

The components of the kettle support assembly 526 of FIG. 47 are shown within representative portions of a surrounding environment of a popcorn machine. It will be appreciated that while the construction of the kettle support assembly 526 is shown having both slidable movement and vertical or height adjustment, either of these features could be provided and/or used exclusively. Both features permit enhanced access to the kettle assembly 10 during use, and make it easier to clean surfaces within the cavity. The ability to slide the kettle assembly 10 away from the center of the cavity while also permitting entry to the cavity through openings of a plurality of side panels can further significantly improve the ease with which an operator can reach into the cavity to clean or otherwise service a popcorn machine.

In light of the structures described herein with respect to the above example embodiments, instead of having to ship a popcorn machine in a fully assembled condition, one may use a new, advantageous method of shipping a popcorn machine. The new method of shipping a popcorn machine includes the steps of providing two or more shipping containers, loading into one of the shipping containers an upper unit of the popcorn machine, loading into one of the shipping containers a base unit of the popcorn machine, loading into one or more of the shipping containers a plurality of columns that are configured to be slidably connected to the upper and base units after the upper and base units and the plurality of columns have been shipped in the shipping containers, loading into one or more of the shipping containers a plurality of side panels that are configured to extend within the respective spaces located between the upper and base units and between spaced apart columns after the upper and base units and the plurality of columns and the plurality of side panels have been shipped in the shipping containers, and loading into one of the shipping containers a kettle assembly that is configured to be supported by the upper assembly after the upper and base units and the plurality of columns and the plurality of side panels have been shipped in the shipping containers. It will be appreciated that with this method, the disassembled components of the popcorn machine may be grouped and more efficiently packed in the two or more containers, resulting in more compact and higher density loading of at least two containers that each can be delivered by one individual, without a lift on the rear of a delivery truck.

For instance, within a first container and using cardboard, foam or other suitable packing materials, an upper unit may be loaded so as to lie in its usual horizontal orientation, while a plurality of columns may be loaded to lie horizontally, which is perpendicular to their usual orientation. The kettle assembly may be loaded to lie between the columns. However, due to the height of the kettle bowls and the kettle closure assembly, the kettle assembly may be most efficiently loaded by loading an inner kettle bowl that is connected to an outer kettle bowl, and separately loading the kettle closure assembly. Then, within a second container and similarly using suitable packing materials, a base unit may be loaded so as to lie in its usual horizontal orientation, while a plurality of side panels may be loaded to lie horizontally, which is perpendicular to their usual orientation. Using this method of shipping a popcorn machine should save shipping costs and reduce the cost of inadvertent damage during shipment. This is made possible by the modular construction of the popcorn machine, which permits simple and quick assembly of the machine after the components have been shipped in the shipping containers.

It will be appreciated that popcorn machines and components for popcorn machines that are constructed in accordance with the present disclosure may be provided in various configurations individually or in combinations. Any variety of suitable materials of construction, configurations, shapes and sizes for the components and methods of connecting the components and shipping the components may be utilized to meet the particular needs and requirements of an end user. It will be apparent to those skilled in the art that various modifications can be made in the design and construction of such popcorn machines without departing from the scope or spirit of the claimed subject matter, and that the claims are not limited to the preferred embodiments illustrated herein.

What is claimed is:

1. A popcorn machine comprising:
an upper unit spaced from and above a base unit;
a plurality of columns being spaced apart and slidably connected to the upper and base units thereby defining a cavity;
at least three side panels that extend within the respective spaces located between the upper and base units and between spaced apart columns;
a kettle assembly positioned within the cavity;
a first side of the popcorn machine having an opening through which the cavity is accessible; and
at least a second side of the popcorn machine having an opening through which the cavity is accessible.

2. A popcorn machine in accordance with claim 1, wherein the first and second sides of the popcorn machine that include the openings through which the cavity is accessible each include at least one of the at least three side panels, and wherein each of the side panels associated with the openings is movable between an open position and a closed position.

3. A popcorn machine in accordance with claim 2, wherein each of the movable side panels associated with the openings is pivotally movable.

4. A popcorn machine in accordance with claim 3, wherein at least one of the pivotally movable side panels further comprises a movable latch.

5. A popcorn machine in accordance with claim 2, wherein each of the movable side panels associated with the openings is movable by being configured for tool-free removal.

6. A popcorn machine in accordance with claim 1, wherein the upper unit includes upper couplings that slidably receive the columns.

7. A popcorn machine in accordance with claim 1, wherein the slidable connection of each column to the upper unit includes a removable fastener.

8. A popcorn machine in accordance with claim 1, wherein the slidable connection of each column to the upper unit includes a releasable spring lock.

9. A popcorn machine in accordance with claim 1, wherein at least one of the columns further comprises a wiring harness configured for plug and socket connection to electrical cords that are connected to the upper and base units.

10. A side panel for a popcorn machine comprising:
at least one transparent portion;
a first vertical rail that is connected along an edge of the at least one transparent portion and further comprises a portion of a hinge that is configured for pivotal connection to the popcorn machine;
a second vertical rail that is connected along an opposed edge of the at least one transparent portion and that further comprises a latch; and
wherein the latch is movable between a locked position and an unlocked position.

11. A side panel for a popcorn machine in accordance with claim 10, wherein the latch is pivotally movable between the locked and unlocked positions.

12. A side panel for a popcorn machine in accordance with claim 10, wherein the latch is slidably movable between the locked and unlocked positions.

13. A side panel for a popcorn machine in accordance with claim 10, wherein the latch is configured to be held in the locked position by gravity.

14. A side panel for a popcorn machine in accordance with claim 10, wherein the latch includes a handle that is movable to be selectively accessible from a first side of the side panel or from a second side of the side panel.

15. A popcorn machine having at least one side panel having edge lighting comprising:
an upper unit spaced from and above a base unit;
a plurality of columns being spaced apart and connected to the upper and base units;
at least three side panels that extend within the respective spaces located between the upper and base units and between spaced apart columns;
at least one of the side panels further comprising a transparent portion and having a channel connected to an edge of the transparent portion; and
a lighting element configured to be located within the channel and to shine light through the edge of the transparent portion of the side panel.

16. A popcorn machine having at least one side panel having edge lighting in accordance with claim 15, wherein the channel has an H-shaped cross-section having a central web extending between and being connected to opposed upstanding first and second side walls.

17. A popcorn machine in accordance with claim 16, wherein the lighting element is positioned on a first side of the central web adjacent the edge of the transparent portion of the at least one side panel.

18. A popcorn machine having at least one side panel having edge lighting in accordance with claim 16, wherein the lighting element is positioned on a second side of the central web, wherein the central web includes apertures and is disposed between the lighting element and the edge of the transparent portion of the at least one side panel.

19. A popcorn machine having at least one side panel having edge lighting in accordance with claim 15, wherein the lighting element further comprises an LED light strip.

20. A popcorn machine having at least one side panel having edge lighting in accordance with claim 15, wherein the transparent portion of the at least one side panel further comprises etched indicia on at least one surface, wherein the etched indicia is illuminated by the lighting element shining light through the edge of the transparent portion of the side panel.
